(19) United States
(12) Patent Application Publication
(10) Pub. No.: US 2026/0277174 A1
(43) Pub. Date: Sep. 17, 2026

(54) METHOD OF TRAINING NEURAL NETWORK MODEL, AND PLATING APPARATUS

(71) Applicant: EBARA CORPORATION, Tokyo (JP)

(72) Inventors: Aryan PRIYANSHU, Tokyo (JP); Tsubasa ISHII, Tokyo (JP)

(21) Appl. No.: 19/565,228

(22) Filed: Mar. 12, 2026

(30) Foreign Application Priority Data
Mar. 14, 2025 (JP) 2025-040924

(51) Int. Cl. G05B 13/02; C23C 18/16; G05D 5/02

(52) U.S. Cl. CPC G05B 13/027; C23C 18/1601; G05D 5/02

(57) ABSTRACT

To provide a method of training a neural network model based on physics information so that a current density at plating-target surface can be measured with high precision even if a change in plating conditions occurs. This method includes: reading training input data and supervisory data; causing the training input data to be input to a neural network model; outputting, by the neural network model, inference data in accordance with the training input data; calculating, as a first loss metric, a residual between the supervisory data and the output inference data; calculating, as a second loss metric, a residual obtained by substituting the output inference data into an equation describing physics phenomena in a region of a plating solution accommodated between a substrate and an anode in a plating bath; and optimizing parameters of the neural network model by using the first and second loss metrics.

### CROSS REFERENCE TO RELATED APPLICATION

This document claims priority to Japanese Patent Application No. 2025-40924, filed Mar. 14, 2025, the entire contents of which are hereby incorporated by reference.

### BACKGROUND OF THE INVENTION

### Field of the Invention

The present invention relates to a technique for measuring a film thickness distribution of a plating film, and in particular, to a technique for training a neural network model used to measure the film thickness distribution of the plating film.

### Description of the Related Art

In recent years, plating has become one of the important steps in the device manufacturing process. For example, plating is widely adopted for forming fine structures such as wiring of semiconductor integrated circuits and bumps (protruding metal terminals). Control of a film thickness distribution of a plating film (for example, uniformization of the film thickness distribution) is an important factor from the viewpoint of ensuring product performance, reliability, and the like. Techniques for measuring the film thickness distribution fulfill an important role in quality control of the plating film, optimization of the manufacturing process, and the like.

A method of measuring a film thickness distribution of a plating film is disclosed, for example, in Japanese Patent Application Publication No. 2023-160356. This method uses a potential sensor disposed in a vicinity of a peripheral portion of a substrate with a plating-target surface, and a state space model. According to this method, upon measuring a potential with the potential sensor during a formation process of the plating film, the current density of a plating current at the peripheral portion (hereinafter referred to as “peripheral portion current density”) is estimated by executing state estimation processing based on the state space model using the measured potential. Furthermore, a current density at a region inward of the peripheral portion of the substrate is estimated based on the peripheral portion current density. Subsequently, the film thickness distribution of the plating film on the substrate is calculated by using a distribution of the estimated current density (see Japanese Patent Application Publication No. 2023-160356, paragraphs [0043] to [0069]).

On the other hand, a deep learning method has been proposed in which an artificial neural network model (ANN), that is, a neural network model (NN model) is caused to learn physics information such as equations describing physics phenomena based on the laws of physics, phenomenological mathematical models, and the like. A deep learning method based on such physics information or an NN model trained using this method is called a physics-informed neural network model (PINN). For example, a PINN is disclosed in the following Non Patent Literature 1: Raissi, M. et al.: Physics Informed Deep Learning (Part I): Data-driven Solutions of Nonlinear Partial Differential Equations, arXiv preprint arXiv:1711, 10561, 2017.

During plating processing of forming a plating film on a substrate, various parameters (for example, a position and an orientation of a substrate holder) that define conditions of the forming process of the plating film (that is, plating conditions) may change over time. The plating conditions may change from one plating processing to another (for example, the plating conditions may differ between the plating processing of forming a plating film on a first substrate and the plating processing of forming the plating film on a second substrate). Even if such a change in the plating conditions occurs, it is desirable to perform measurement of a film thickness distribution of the plating film with high precision. When the film thickness distribution of the plating film is estimated from a current density distribution, achieving high-precision measurement of this film thickness distribution requires estimating the current density on the substrate with high precision in response to the change in the plating conditions. This is particularly important when monitoring the film thickness distribution of the plating film in real-time.

### SUMMARY OF INVENTION

In view of the above, an object of the present invention is to provide a method of training a neural network model based on physics information, a plating apparatus, and a computer program, so as to make it possible to estimate a current density on a substrate with high precision even if a change in plating conditions occurs.

A method according to a first aspect of the present invention is a method of training a neural network model used for control of a plating apparatus including a plating bath for accommodating a plating solution, a substrate holder for holding a substrate, and an anode disposed in the plating bath so as to be opposite the substrate held by the substrate holder. Upon accepting input data including at least data representing a current density data at a peripheral portion of the substrate, the neural network model is configured to perform inference processing on the input data and calculate inference data representing a potential of the plating solution in a vicinity of the peripheral portion of the substrate. The method includes: reading training input data and supervisory data corresponding to the training input data from a training data storage in which training data is stored; causing the training input data to be input to the neural network model; outputting, by the neural network model, the inference data in accordance with the training input data; calculating, as a first loss metric, a residual between the supervisory data and the output inference data; calculating, as a second loss metric, a residual obtained by substituting the output inference data into an equation describing physics phenomena in a region of the plating solution accommodated between the substrate and the anode in the plating bath; and optimizing parameters of the neural network model by using the first loss metric and the second loss metric.

A plating apparatus according to a second aspect of the present invention includes: a plating bath for accommodating a plating solution; a substrate holder for holding a substrate; an anode disposed in the plating bath so as to be opposite the substrate held by the substrate holder; a sensor configured to measure a potential of the plating solution in a vicinity of a peripheral portion of the substrate held by the substrate holder; and a state estimator configured to calculate, using the measured potential as input, a state estimate representing a current density at the peripheral portion of the substrate, based on an observation model and a state transition model. The state estimator is configured to execute computation based on the observation model by using a neural network model trained using the method according to the first aspect. When a state variable representing the current density at the peripheral portion is input, the trained neural network model is used as a neural network model configured to output an estimate representing the potential of the plating solution in the vicinity of the peripheral portion.

A method according to a third aspect of the present invention is a method of training a neural network model used for control of a plating apparatus including a plating bath for accommodating a plating solution, a substrate holder for holding a substrate, and an anode disposed in the plating bath so as to be opposite the substrate held by the substrate holder. Upon accepting input data including at least data representing a current density data at a peripheral portion of the substrate, the neural network model is configured to perform inference processing on the input data and calculate inference data representing a current density in an inner region located inward of the peripheral portion on the substrate. The method includes: reading training input data and supervisory data corresponding to the training input data from a training data storage in which training data is stored; causing the training input data to be input to the neural network model; outputting, by the neural network model, the inference data in accordance with the training input data; calculating, as a loss metric, a residual obtained by substituting the supervisory data and the output inference data into an equation describing physics phenomena in a region including a boundary between a plating-target surface of the substrate and the plating solution in the plating bath; and optimizing parameters of the neural network model by using the loss metric.

A plating apparatus according to a fourth aspect of the present invention includes: a plating bath for accommodating a plating solution; a substrate holder for holding a substrate; an anode disposed in the plating bath so as to be opposite the substrate held by the substrate holder; a sensor configured to measure a potential of the plating solution in a vicinity of a peripheral portion of the substrate held by the substrate holder; and a state estimator configured to calculate, from the measured potential, a state estimate representing a current density at the peripheral portion of the substrate; and a current density calculator configured to calculate, from the state estimate calculated by the state estimator, a distribution of a current density in an inner region of the substrate located inward of the peripheral portion of the substrate, by using the neural network model trained using the method according to the third aspect.

A computer program including a plurality of instructions according to a fifth aspect of the present invention causes a processor to implement the method according to the first aspect of the third aspect when the plurality of instructions are executed by the processor.

### BRIEF DESCRIPTION OF DRAWINGS

FIG. 1 is a functional block diagram showing a schematic configuration of a neural network (NN) model trainer according to a first embodiment of the present invention.

FIG. 2 is a schematic diagram showing a configuration of a plating module for performing electroplating processing.

FIG. 3 is a plan view showing an example of a plating-target surface of a substrate.

FIG. 4 is a flowchart showing an example of a processing procedure of a method of training a neural network model according to the first embodiment.

FIG. 5 is a functional block diagram showing a schematic configuration of a neural network (NN) model trainer according to a second embodiment of the present invention.

FIG. 6 is a flowchart showing an example of a processing procedure of a method of training a neural network model according to the second embodiment of the present invention.

FIG. 7 is a schematic configuration diagram of a hardware configuration example that realizes the NN model trainer according to the first embodiment and the second embodiment.

FIG. 8 is a perspective view showing an overall configuration of a plating apparatus according to a third embodiment of the present invention.

FIG. 9 is a plan view of the plating apparatus of the third embodiment as viewed from above.

FIG. 10 is a schematic configuration diagram of a hardware configuration example that realizes a control module according to the third embodiment.

FIG. 11 is a cross-sectional view schematically showing a configuration of a plating module of the third embodiment.

FIG. 12 is a schematic plan view of the substrate.

FIG. 13 is an enlarged view of a surrounding region of a conduit in the plating module of the third embodiment.

FIG. 14 is a schematic diagram of a shield and the substrate of the third embodiment as viewed from below (negative Z-axis direction).

FIG. 15 is a functional block diagram showing a schematic configuration of the control module in the third embodiment.

FIG. 16 is a diagram for describing a current density at a position (θ,ψ) in a peripheral portion of the substrate.

FIG. 17 is a diagram showing a schematic configuration of an example of a neural network model of the third embodiment.

FIG. 18 is a diagram showing a schematic configuration of another example of a neural network model of the third embodiment.

FIG. 19 is a flowchart showing an example of a processing procedure for calculating a film thickness distribution according to the third embodiment.

FIG. 20 is a cross-sectional view schematically showing a configuration of a plating module of a variation of the third embodiment.

FIG. 21 is a cross-sectional view schematically showing a configuration of a plating module in a fourth embodiment of the present invention.

### DETAILED DESCRIPTION OF THE PREFERRED EMBODIMENTS

Hereinafter, various embodiments according to the present invention will be described in detail with reference to the drawings. Note that in the drawings, constituent elements denoted by the same reference numerals have the same configurations and functions.

### FIRST EMBODIMENT

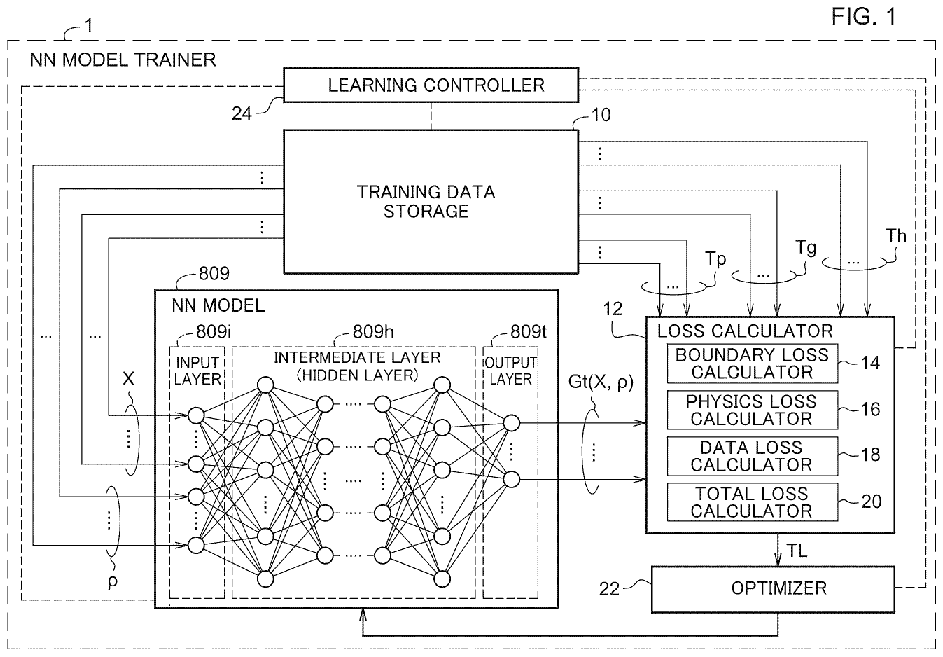

FIG. 1 is a functional block diagram showing a schematic configuration of a neural network (NN) model trainer 1 according to a first embodiment. The NN model trainer 1 has a function of training a neural network model (NN model) 809 using deep learning based on physics information relating to plating processing and generating a neural network model based on the physics information. Examples of main physics information include equations that describe physics phenomena based on the laws of physics, equations that describe physics phenomena based on phenomenological mathematical models that do not strictly reflect the laws of physics, or equations that describe physics phenomena based on a combination of the laws of physics and phenomenological mathematical models. In the present description, such equations are referred to as “governing equations”. The physics information is intended to include information related to governing equations. As described below, the generated neural network model is used for control of a plating apparatus that performs plating processing.

The NN model trainer 1 includes a training data storage 10, a loss calculator 12, an optimizer 22, and a learning controller 24. The learning controller 24 is configured to control operations of the training data storage 10, the loss calculator 12, the optimizer 22, and the NN model 809. The training data storage 10 has a data storage region in which a training dataset for deep learning is stored. In order to cause the NN model 809 to perform supervised learning, the training dataset includes a combination of a large number of training input data elements to be provided to the NN model 809 and supervisory data elements (that is, data elements with correct labels) respectively corresponding to the training input data elements. Note that the training dataset of the present embodiment includes a dataset for supervised learning, but may include a dataset for semi-supervised learning.

As shown in FIG. 1, the NN model 809 is a hierarchical artificial neural network including an input layer 809i, an output layer 809t, and an intermediate layer (hidden layer) 809h that couples the input layer 809i to the output layer 809t. The NN model 809 is implemented as a deep learning model. The NN model 809 may include an existing feedforward neural network, a convolutional neural network (CNN), a recurrent neural network such as long short-term memory (LSTM), or a transformer with an attention mechanism. The NN model 809 may be achieved by a computer program, by a hardware configuration such as semiconductor integrated circuit, or by a combination of a computer program and a hardware configuration.

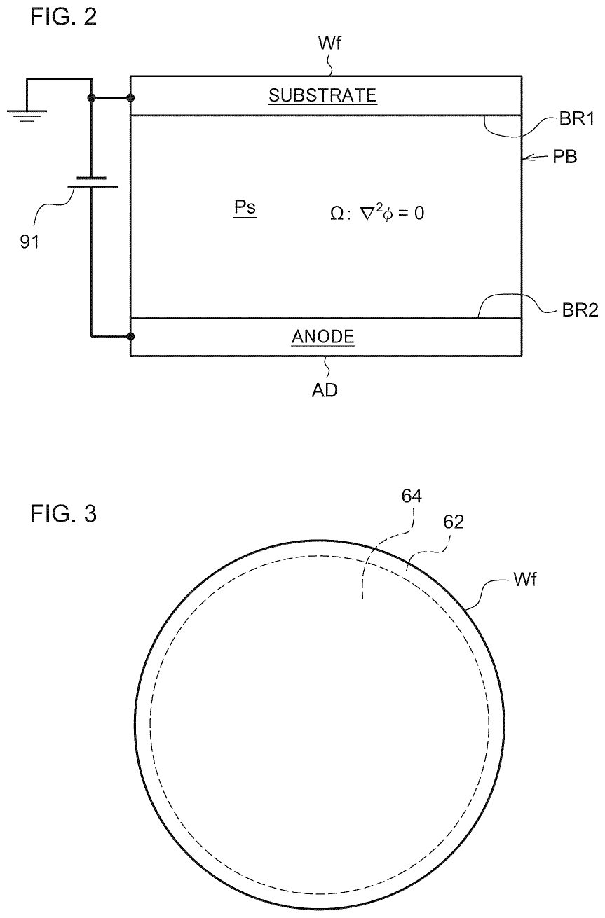

FIG. 2 is a schematic diagram showing a configuration of a plating module for performing electroplating processing in the plating apparatus. The plating module in FIG. 2 includes a plating bath PB accommodating a plating solution Ps, a substrate Wf held by a substrate holder (not shown), and an anode AD disposed in the plating bath PB so as to be opposite the substrate Wf. The substrate Wf is connected to a negative terminal of an external power supply 91 via electrical wiring, and a plating-target surface of the substrate Wf functions as a cathode. The anode AD is connected to a positive terminal of the external power supply 91 via electrical wiring. A boundary BR1 exists between a region of the plating solution Ps and the substrate Wf, and the boundary BR2 also exists between the region of the plating solution Ps and the anode AD. The region of the plating solution Ps is governed by a governing equation Ω that describes physics phenomena. In the example of FIG. 2, the governing equation Ω is a Laplace's equation, but the present invention is not limited thereto.

FIG. 3 is a plan view showing an example of the plating-target surface of the substrate Wf. As shown in FIG. 3, the substrate Wf has a peripheral portion 62 extending along an outer circumferential direction of the substrate Wf, and an inner region 64 located inward of the peripheral portion 62 of the plating-target surface of the substrate Wf. A plurality of electrical contacts (not shown) along the outer circumferential direction of the substrate Wf are provided at the peripheral portion 62 of the substrate Wf, and the electrical contacts function as electrodes through which current that has flowed into an underlying film of the substrate Wf during the plating processing subsequently flows out.

The NN model 809 is trained by the NN model trainer 1 in FIG. 1 so as to perform inference processing on input data including current density data representing a current density at the peripheral portion 62 (hereinafter also referred to as “peripheral portion current density”) of the substrate Wf and parameter data representing parameters that define plating conditions relating to constituent elements of the plating module, and to calculate inference data representing a potential of the plating solution Ps in a vicinity of the peripheral portion of the substrate Wf, upon accepting the input data. It is desirable that the current density data is expressed as a vector quantity representing a current density at a plurality of points set along the outer circumferential direction of the substrate Wf at the peripheral portion 62, but the present invention is not limited thereto. The inference data can be calculated as a vector quantity representing a potential at a plurality of points set along the outer circumferential direction of the substrate Wf on the peripheral portion 62, but the inference data is not limited thereto, and may also be calculated as a scalar quantity representing a potential at one point on the peripheral portion 62 of the substrate Wf. Examples of the parameter data that define the plating conditions include data representing a position and an orientation of the substrate holder, a rotation speed of the substrate Wf, a type of the plating solution Ps, electrical conductivity of the plating solution Ps, a polarization gradient, a plating current value, and a plating time, but the present invention is not limited thereto. A detailed example of the parameter data will be described below.

The learning controller 24 can selectively read, from among the training dataset stored in the training data storage 10, a pair of current density data X representing the peripheral portion current density and parameter data ρ that defines the plating conditions as training input data, and perform control to cause the current density data X and the parameter data ρ to be input to the input layer 809i of the NN model 809. In parallel, the learning controller 24 can selectively read, from among the training data set, supervisory data elements Tp, Tg, and Th corresponding to the pair of the current density data X and parameter data ρ, and perform control to provide the supervisory data elements Tp, Tg, and Th to the loss calculator 12. Upon accepting the training input data including the current density data X and the parameter data ρ, the NN model 809 performs inference processing on the training input data and calculates inference data Gt(X,ρ) representing the potential of the plating solution Ps in the vicinity of the peripheral portion of the substrate Wf.

The loss calculator 12 includes a boundary loss calculator 14, a physics loss calculator 16, a data loss calculator 18, and a total loss calculator 20. The boundary loss calculator 14 has a function of calculating, as a first loss metric, a residual (hereinafter also referred to as “boundary residual”) between the inference data Gt(X,ρ) and the supervisory data elements Tg and Th for boundary conditions, for a plurality of points (x,y) on a boundary of the region (target region) of the plating solution Ps in the plating bath PB, based on predetermined boundary conditions. The boundary conditions are conditions that the solution of the governing equation to be described below is to satisfy on the boundary.

For example, the boundary conditions can be expressed as loss functions of the following equations (1) and (2).

$${LS}_{Dirichlet} = {\sum }_{i = 1} {{w}_{i} ( NN ( {x}_{i} , {y}_{i} ) - g ( {x}_{i} , {y}_{i} ) )}^{2} \qquad ( 1 )$$

$${LS}_{Neumann} = {\sum }_{j = 1} {{w}_{j} ( \frac{\partial NN ( {x}_{j} , {y}_{j} )}{\partial n} - h ( {x}_{j} , {y}_{j} ) )}^{2} \qquad ( 2 )$$

Here, equation (1) is a loss function representing the Dirichlet boundary condition, and equation (2) is a loss function representing the Neumann boundary condition. (xᵢ,yᵢ) are coordinates of points belonging to a point set consisting of points on the boundary BR1 between the substrate Wf and the plating solution Ps and points on a boundary BR2 between the anode AD and the plating solution Ps as shown in FIG. 2. (xⱼ,yⱼ) are also coordinates of points belonging to a point set consisting of points on the boundaries BR1 and BR2. wᵢ and wⱼ are weights.

According to the Dirichlet boundary condition of equation (1), a boundary residual LS_{Dirichlet} is a mean squared error (MSE) between a value NN(xᵢ,yᵢ) of the inference data Gt(X,ρ) and a value g(xⱼ,yⱼ) of the supervisory data element Tg. According to the Neumann boundary condition of equation (2), a boundary residual LS_{Neumann} is a mean squared error (MSE) between a normal direction derivative value of the inference data Gt(X,ρ) and a value h(xⱼ,yⱼ) of the supervisory data element Th.

Note that the mean squared error is used in equations (1) and (2), but the present invention not limited thereto. For example, instead of the mean squared error, a mean absolute error (MAE) or a mean squared logarithmic error (MSLE) may be used. The boundary conditions are not limited to the Dirichlet boundary condition and the Neumann boundary condition. A linear combination of loss functions representing the Dirichlet boundary condition and the Neumann boundary condition (Robin boundary condition) may be used, or a loss function representing a periodic boundary condition (condition requiring that a solution repeats periodically at the boundary of the target region) may be used.

The physics loss calculator 16 has a function of calculating a residual (hereinafter also referred to as “physics residual”) by substituting the inference data Gt(X,ρ) into a governing equation that describes physics phenomena in the target region, and outputting this residual as a second loss metric. As the governing equation, a partial differential equation (PDE) can be used. In the present embodiment, the Laplace's equation Ω in FIG. 2 is applied as an example of the governing equation. A physics residual LS_{PDE} according to a weak form of the Laplace's equation Ω is given by the following equation (3).

$${LS}_{PDE} = {\sum }_{k = 1} {{w}_{k} ( Δ NN ( {x}_{k} , {y}_{k} ) \cdot Δ v ( {x}_{k} , {y}_{k} ) )}^{2} \qquad ( 3 )$$

In this equation, Δ is the Laplacian, that is, the Laplace operator, ΔNN(xₖ,yₖ) is a vector obtained by applying the Laplacian to the inference data Gt(X,ρ) at a point (xₖ,yₖ) representing predetermined coordinates, Δv is a vector obtained by applying the Laplacian to a test function v at the point (xₖ,yₖ) representing the predetermined coordinates, and wₖ is a weight. Equation (3) represents a weighted sum of squared inner products of two vectors.

The data loss calculator 18 has a function of calculating, as a third loss metric, a residual (hereinafter also referred to as “data residual”) between the inference data Gt(X,ρ) and the supervisory data element Tp for a data point, for the data point (xₛ,yₛ) representing predetermined coordinates in the target region. For example, a data residual LS_{Data} is given by the following equation (4).

$${LS}_{Data} = {\sum }_{s = 1} {{w}_{s} ( NN ( {x}_{s} , {y}_{s} ) - p ( {x}_{s} , {y}_{s} ) )}^{2} \qquad ( 4 )$$

According to equation (4), the data residual LS_{Data} is expressed as a mean squared error between a value NN(xₛ,yₛ) of the inference data Gt(X,ρ) and a value p(xₛ,yₛ) of the supervisory data element Tp. The total loss calculator 20 has a function of calculating a total loss metric LS based on the first loss metric, the second loss metric, and the third loss metric described above. For example, the total loss metric LS is given by the following equation (5).

$$LS = {L}_{Dirichlet} + {LS}_{Neumann} + {LS}_{PDE} + {LS}_{Data} \qquad ( 5 )$$

While in the present embodiment, the total loss metric LS is calculated by using the first loss metric (boundary residual), the second loss metric (physics residual), and the third loss metric (data residual), the total loss metric LS may instead be calculated by using the first loss metric (boundary residual) and the second loss metric (physics residual) without using the third loss metric (data residual).

The optimizer 22 has a function of optimizing, based on a predetermined machine learning algorithm, a parameter group (for example, weights between nodes) inside the NN model 809 by using the total loss metric LS calculated by the total loss calculator 20. A backpropagation learning algorithm including an error backpropagation method and a gradient descent method can be used as the machine learning algorithm. For example, stochastic gradient descent (SGD), a momentum method (momentum SGD), or an adaptive moment estimation method (Adam) can be used as the gradient descent method, but the present invention is not limited thereto.

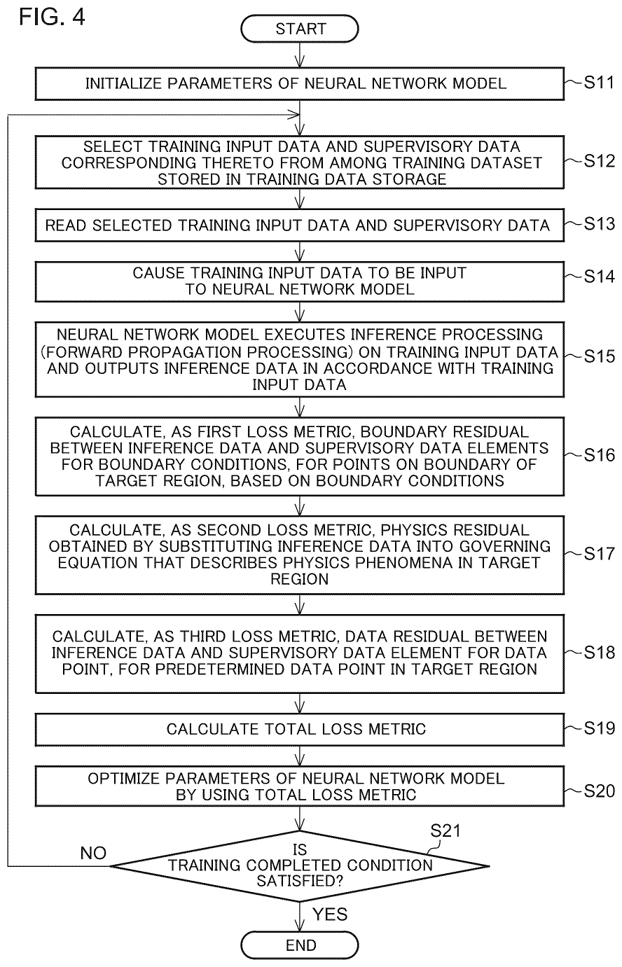

Next, a processing procedure by the above NN model trainer 1 will be described hereinafter. FIG. 4 is a flowchart showing an example of the processing procedure of a method of training the NN model 809.

Referring to FIG. 4, the learning controller 24 first initializes the parameter group inside the NN model 809 (step S11). At this time, for example, the learning controller 24 may initialize values of the parameter group to random or pseudo-random values, or may set the values of the parameter group to an initial parameter group prepared in advance.

Next, the learning controller 24 selects training input data and supervisory data corresponding thereto from the training dataset stored in the training data storage 10 (step S12), and reads the selected training input data and supervisory data from the training data storage 10 (step S13). At this time, as described above, the learning controller 24 can selectively read, from the training data storage 10, the pair of the current density data X and the parameter data ρ that defines the plating conditions as the training input data, and selectively read the supervisory data elements Tp, Tg, and Th corresponding to the pair of the current density data X and the parameter data ρ. Subsequently, the learning controller 24 causes the current density data X and the parameter data ρ to be input to the NN model 809 (step S14).

The NN model 809 performs the inference processing (forward propagation processing) on input training input data X and ρ, and outputs the inference data Gt(X,ρ) representing the potential of the plating solution Ps in the vicinity of the peripheral portion of the substrate Wf (step S15).

Next, the boundary loss calculator 14 has calculates, as the first loss metric, the boundary residual between the inference data Gt(X,ρ) and the supervisory data elements Tg and Th for the boundary conditions, for the plurality of points (x,y) on the boundary of the target region, based on the predetermined boundary conditions (step S16). The physics loss calculator 16 calculates, as the second loss metric, the physics residual obtained by substituting the inference data Gt(X,ρ) into the governing equation that describes the physics phenomena in the target region (step S17). The data loss calculator 18 calculates, as the third loss metric, the data residual between the inference data Gt(X,ρ) and the supervisory data element Tp for the data point, for the predetermined data point in the target region (step S18). The total loss calculator 20 calculates the total loss metric based on the first loss metric, the second loss metric, and the third loss metric (step S19).

The optimizer 22 optimizes, based on the predetermined machine learning algorithm, the parameter group inside the NN model 809 by using the calculated total loss metric (step S20). Subsequently, if a training completion condition determined in advance is satisfied (YES in step S21), the learning controller 24 terminates the processing. If the training completion condition is not satisfied (NO in step S21), the learning controller 24 returns to step S12, selects new training input data and supervisory data corresponding thereto (step S12), and continues the processing from step S13 onward.

As described above, according to the present embodiment, the NN model 809 based on the physics information can be obtained. Upon accepting the input data including the current density data and the parameter data that defines the plating conditions, the NN model 809 trained based on the physics information can calculate the inference data representing the potential of the plating solution Ps in the vicinity of the peripheral portion of the substrate Wf with high precision. As described below, by performing the inference processing by using a neural network model with the same structure and parameter group as such a NN model 809, a state estimate representing the current density at the peripheral portion can be calculated with high precision even if a change in the plating conditions occurs during the plating processing or between different instances of the plating processing. This enhances estimation precision of a current density at the plating-target surface, and also enhances estimation precision of a film thickness distribution of a plating film. Note that the NN model 809 can be trained so as to learn both a change in the plating conditions based on the parameter data ρ and a temporal change in the plating conditions not based on the parameter data ρ.

### SECOND EMBODIMENT

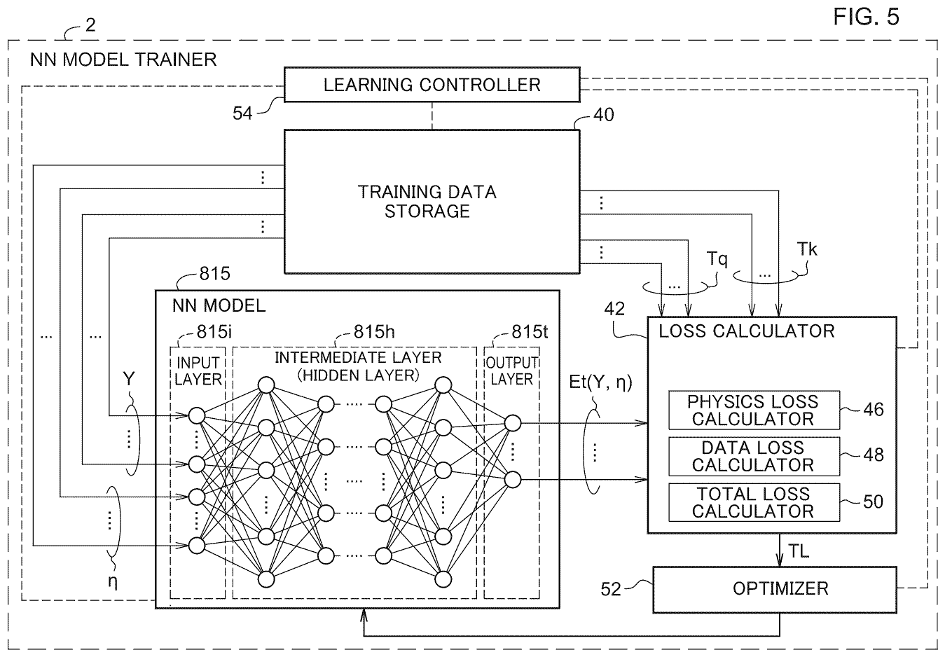

Next, a second embodiment will be described. FIG. 5 is a functional block diagram showing a schematic configuration of a neural network (NN) model trainer 2 according to the second embodiment. Similar to the NN model trainer 1 of the first embodiment, the NN model trainer 2 has a function of training a neural network model (NN model) 815 using deep learning based on physics information relating to plating processing and generating a neural network model based on the physics information. As described below, the generated neural network model is used for control of a plating apparatus that performs plating processing.

The NN model trainer 2 includes a training data storage 40, a loss calculator 42, an optimizer 52, and a learning controller 54. The learning controller 54 controls operations of the training data storage 40, the loss calculator 42, the optimizer 22, and the NN model 815.

As shown in FIG. 5, the NN model 815 is a hierarchical artificial neural network including an input layer 815i, an output layer 815t, and an intermediate layer (hidden layer) 815h that couples the input layer 815i to the output layer 815t. The NN model 815 is implemented as a deep learning model. The NN model 815 may include an existing feedforward neural network, a convolutional neural network (CNN), a recurrent neural network such as LSTM, or a transformer with an attention mechanism. The NN model 815 may be achieved by a computer program, by a hardware configuration such as semiconductor integrated circuit, or by a combination of a computer program and a hardware configuration.

The NN model 815 is trained by the NN model trainer 2 in FIG. 5 so as to perform inference processing on the input data including the current density data representing the current density at the peripheral portion 62 (hereinafter also referred to as “peripheral portion current density”) of the substrate Wf shown in FIGS. 2 and 3 and the parameter data representing the parameters that define the plating conditions relating to the constituent elements of the plating module, and to calculate inference data representing a current density at the inner region 64 located inward of the peripheral portion 62 on the substrate Wf, upon accepting the input data. It is desirable that the current density data is expressed as the vector quantity representing the current density at the plurality of points set along the outer circumferential direction of the substrate Wf at the peripheral portion 62, but the present invention is not limited thereto. The inference data can be calculated as a current density distribution representing a current density at a plurality of points in the inner region 64. Examples of the parameter data that define the plating conditions include data representing the position and the orientation of the substrate holder, the rotation speed of the substrate Wf, the type of the plating solution Ps, the electrical conductivity of the plating solution Ps, the polarization gradient, the plating current value, and the plating time, but the present invention is not limited thereto. A detailed example of the parameter data will be described below.

The learning controller 54 can selectively read, from among a training dataset stored in the training data storage 40, a pair of current density data Y representing the peripheral portion current density and parameter data η that defines the plating conditions as training input data, and perform control to cause the current density data Y and the parameter data η to be input to the input layer 815i of the NN model 815. In parallel, the learning controller 54 can selectively read, from among the training data set, supervisory data elements Tq and Tk corresponding to the pair of the current density data Y and parameter data η, and perform control to provide the supervisory data elements Tq and Tk to the loss calculator 42. Upon accepting the training input data including the current density data Y and the parameter data η, the NN model 815 performs inference processing on the training input data and calculates inference data Et(Y,η) representing the current density distribution at the inner region 64 of the substrate Wf.

The loss calculator 42 includes a physics loss calculator 46, a data loss calculator 48, and a total loss calculator 50. The physics loss calculator 46 utilizes a governing equation that describes physics phenomena in a boundary region including a boundary (interface) between the plating-target surface of the substrate Wf in the plating bath PB and the plating solution Ps. The physics loss calculator 46 has a function of calculating a residual (hereinafter also referred to as “physics residual”) by substituting the supervisory data element Tk for a boundary condition and the inference data Et(Y,η) into the governing equation, and outputting this residual as a first loss metric. In the present embodiment, a polarization curve model representing a relationship between an electrode potential and a current density can be used as the governing equation, but the present invention is not limited thereto. The polarization curve model is a phenomenological mathematical model that describes physics phenomena in the boundary region. In the polarization curve model, a function or a lookup table determined in advance based on a result of a numerical simulation or an actual observation result may be used.

For example, the polarization curve model can be expressed by an equation ΔE−f(j)=0. Here, f(j) is a function relating to a current density j, and ΔE(=φ_{E}−φ_{w}) is an electrode potential. The electrode potential ΔE can be expressed as a difference between an internal potential φ_{E} of the plating solution (electrolyte solution) and an internal potential φ_{w} of a cathode electrode. A value of the electrode potential ΔE is given by the supervisory data element Tk for the boundary condition.

For example, a physics residual LSS_{PH} is given by the following equation (6).

$${LSS}_{PH} = {\sum }_{k = 1} {w}_{k} {\vert Δ E ( {x}_{k} , {y}_{k} ) - f ( NN ( {x}_{k} , {y}_{k} ) ) \vert}^{2} \qquad ( 6 )$$

In this equation, f( ) is a function of the polarization curve model, NN(xₖ,yₖ) is a current density value indicated by the inference data Et(Y,η) at a point (xₖ,yₖ) representing predetermined coordinates of the boundary region, ΔE(xₖ,yₖ) is the electrode potential indicated by the supervisory data element Tk at the point (xₖ,yₖ), and wₖ is a weight. Equation (6) represents a weighted sum of squared differences between ΔE(xₖ,yₖ) and f(NN(xₖ,yₖ)).

The data loss calculator 48 has a function of calculating, as a second loss metric, a residual (hereinafter also referred to as “data residual”) between the inference data Et(Y,η) and the supervisory data element Tq for a data point, for a data point (x_{c},y_{c}) representing predetermined coordinates in a target region determined in advance. For example, a data residual LSS_{Data} is given by the following equation (7).

$${LSS}_{Data} = {\sum }_{c = 1} {{w}_{c} ( NN ( {x}_{c} , {y}_{c} ) - q ( {x}_{c} , {y}_{c} ) )}^{2} \qquad ( 7 )$$

According to equation (7), the data residual LSS_{Data} is expressed as a mean squared error between a value NN(x_{c},y_{c}) of the inference data Et(Y,η) and a value q(x_{c},y_{c}) of the supervisory data element Tq. The total loss calculator 50 has a function of calculating a total loss metric LSS based on the first loss metric and the second loss metric described above. For example, the total loss metric LSS is given by the following equation (8).

$$LSS = {LSS}_{PH} + {LSS}_{Data} \qquad ( 8 )$$

While in the present embodiment, the total loss metric LSS is calculated by using the first loss metric (physics residual) and the second loss metric (data residual), the total loss metric LSS may instead be calculated by using the first loss metric (physics residual) without using the second loss metric (data residual).

The optimizer 52 has a function of optimizing, based on a predetermined machine learning algorithm, a parameter group (for example, weights between nodes) inside the NN model 815 by using the total loss metric LSS calculated by the total loss calculator 50. A backpropagation learning algorithm including an error backpropagation method and a gradient descent method can be used as the machine learning algorithm. For example, stochastic gradient descent (SGD), a momentum method (momentum SGD), or an adaptive moment estimation method (Adam) can be used as the gradient descent method, but the present invention is not limited thereto.

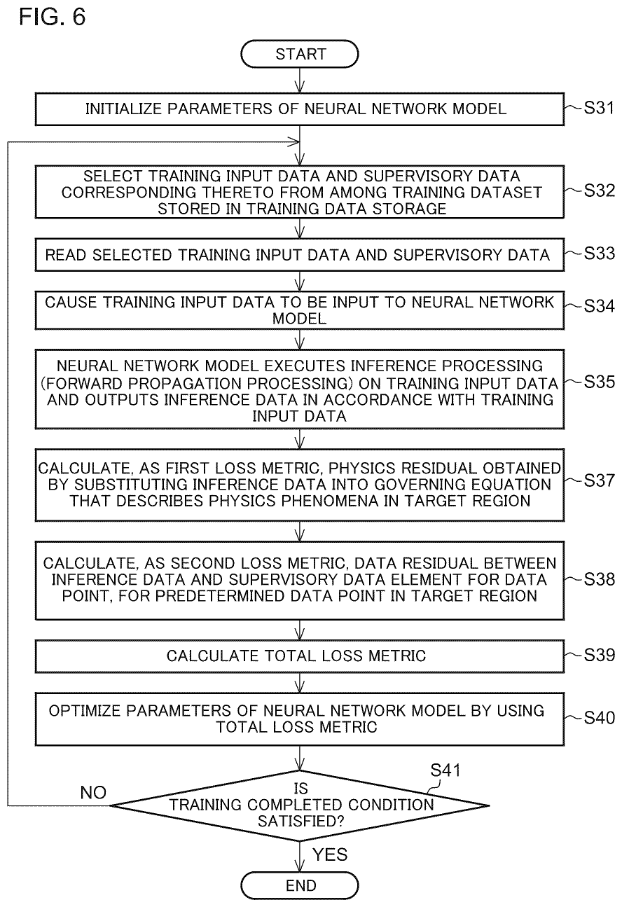

Next, a processing procedure by the above NN model trainer 2 will be described hereinafter. FIG. 6 is a flowchart showing an example of the processing procedure of a method of training the NN model 815.

Referring to FIG. 6, the learning controller 54 first initializes the parameter group inside the NN model 815 (step S31). At this time, for example, the learning controller 54 may initialize values of the parameter group to random or pseudo-random values, or may set the values of the parameter group to an initial parameter group prepared in advance.

Next, the learning controller 54 selects training input data and supervisory data corresponding thereto from the training dataset stored in the training data storage 40 (step S32), and reads the selected training input data and supervisory data from the training data storage 40 (step S33). At this time, as described above, the learning controller 54 can selectively read, from the training data storage 40, the pair of the current density data Y and the parameter data η that defines the plating conditions as the training input data, and selectively read the supervisory data elements Tq and Tk corresponding to the pair of the current density data Y and the parameter data η. Subsequently, the learning controller 54 causes the current density data Y and the parameter data η to be input to the NN model 815 (step S34).

The NN model 815 performs the inference processing (forward propagation processing) on input training input data Y and q, and outputs the inference data Et(Y,η) representing the current density distribution at the inner region 64 of the substrate Wf (step S35).

Next, the physics loss calculator 46 calculates, as the first loss metric, the physics residual obtained by substituting the supervisory data element Tk for the boundary condition and the inference data Et(Y,η) into the governing equation that describes the physics phenomena in the boundary region (step S37). The data loss calculator 48 calculates, as the second loss metric, the data residual between the inference data Et(Y,η) and the supervisory data element Tq for the data point, for the predetermined data point in the target region (step S38). The total loss calculator 50 calculates the total loss metric based on the first loss metric and the second loss metric (step S39).

The optimizer 52 optimizes, based on the predetermined machine learning algorithm, the parameter group inside the NN model 815 by using the calculated total loss metric (step S40). Subsequently, if a training completion condition determined in advance is satisfied (YES in step S41), the learning controller 54 terminates the processing. If the training completion condition is not satisfied (NO in step S41), the learning controller 54 returns to step S32, selects new training input data and supervisory data corresponding thereto (step S32), and continues the processing from step S33 onward.

As described above, according to the present embodiment, the NN model 815 based on the physics information can be obtained. Upon accepting the input data including the current density data and the parameter data that defines the plating conditions, the NN model 815 trained based on the physics information can calculate the inference data representing the current density distribution at the inner region 64 of the substrate Wf with high precision. As described below, if a neural network model with the same structure and parameter group as such a NN model 815 is used, an estimated quantity representing the current density distribution at the inner region 64 can be calculated with high precision even if a change in the plating conditions occurs. This enhances estimation precision of a current density at the plating-target surface, and also enhances estimation precision of a film thickness distribution of a plating film. Note that the NN model 815 can be trained so as to learn both a change in the plating conditions based on the parameter data η and a temporal change in the plating conditions not based on the parameter data η.

The NN model trainer 1 and the NN model trainer 2 according to the first embodiment and the second embodiment described above may be achieved by one computer including one or more processors, or may be achieved by a plurality of computers connected to each other via a communication path. All or part of constituent elements of the NN model trainers 1 and 2 may be achieved by one or more processors including one or more computation apparatuses (processing units) that execute processing through software or firmware code (plurality of instructions) read from a non-volatile memory (computer-readable recording medium). For example, a central processing unit (CPU), a graphics processing unit (GPU), or a neural network processing unit (NPU) can be used as the computation apparatus. GPUs and NPUs are computation apparatuses designed to have a structure suitable for computation (for example, tensor computation) based on artificial neural network (ANN), that is, a neural network model. Alternatively, all or part of the constituent elements of a control module 800 can be achieved by one or more processors having a semiconductor integrated circuit such as a field-programmable gate array (FPGA). Alternatively, all or part of the constituent elements of the NN model trainers 1 and 2 may be achieved by one or more processors including a combination of a semiconductor integrated circuit such as an FPGA and computation apparatus such as a CPU or a GPU.

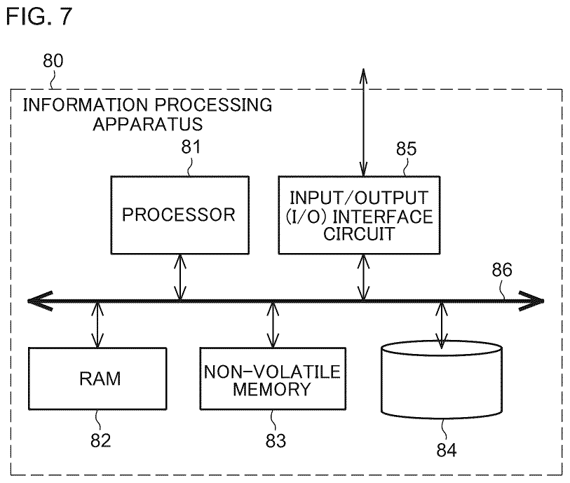

FIG. 7 is a schematic configuration diagram of an information processing apparatus (computer) 80 being a hardware configuration example for realizing the NN model trainers 1 and 2. The information processing apparatus 80 includes a processor 81, a random access memory (RAM) 82, a non-volatile memory 83, a large-capacity storage 84, an input/output (I/O) interface circuit 85, and a signal path 86. The signal path 86 is a bus for connecting the processor 81, the RAM 82, the non-volatile memory 83, the storage 84, and the input/output (I/O) interface circuit 85 to each other. The RAM 82 is a data storage region used when the processor 81 executes digital signal processing. When a computation apparatus such as a CPU or a GPU is incorporated in the processor 81, the non-volatile memory 83 can have a data storage region in which software code executed by the processor 81 is stored. For example, the input/output (I/O) interface circuit 85 can be connected to user interface equipment (not shown).

Hereinafter, an embodiment will be described of a plating apparatus having a neural network model with the same structure and parameter group as the NN models 809 and 815 trained by using the methods according to the first embodiment and the second embodiment.

### THIRD EMBODIMENT

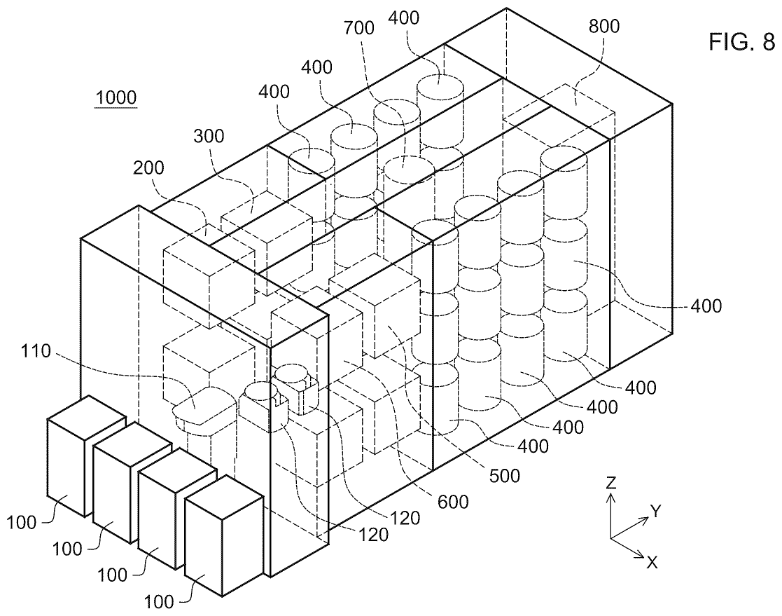

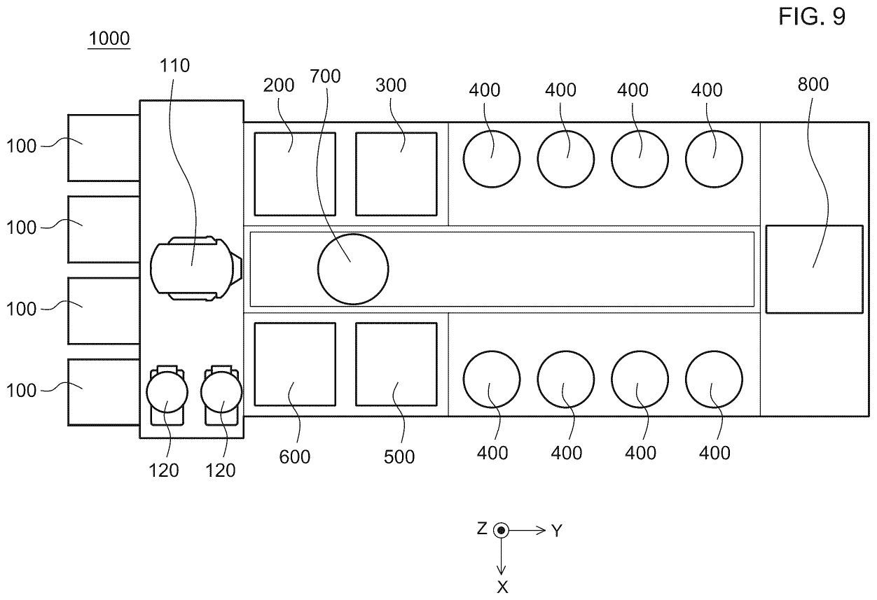

FIG. 8 is a perspective view showing an overall configuration of a plating apparatus 1000 according to a third embodiment. FIG. 9 is a plan view of the plating apparatus 1000 of the present embodiment as viewed from above. For convenience of description, in FIG. 9, an upper part of a housing of the plating apparatus 1000 is not shown to allow an internal structure of the plating apparatus 1000 to be visible. Note that an X-axis, a Y-axis, and a Z-axis shown in the drawings are orthogonal to each other.

As shown in FIGS. 8 and 9, the plating apparatus 1000 includes a load port 100, a transfer robot 110, an aligner 120, a pre-wet module 200, a pre-soak module 300, a plating module 400, a cleaning module 500, a spin rinse dryer 600, a transfer device 700, and the control module 800.

The load port 100 is a module for loading a substrate accommodated in a cassette (not shown) such as a front-opening unified pod (FOUP) into the plating apparatus 1000, unloading the substrate from the plating apparatus 1000 into a cassette, and the like. In the present embodiment, four load ports 100 are disposed side by side along a horizontal direction (X-axis direction), but the number and arrangement of the load ports 100 are not limited thereto and may be freely selected. The transfer robot 110 is a robot for transferring the substrate, and has a function of handing over the substrate between the load port 100, the aligner 120, and the transfer device 700. The transfer robot 110 and the transfer device 700 can hand over the substrate via a temporary stand (not shown) when handing over the substrate between the transfer robot 110 and the transfer device 700.

The aligner 120 is a module for aligning a position of an orientation flat, a notch, and the like of the substrate in a predetermined direction. In the present embodiment, two aligners 120 are disposed side by side along a horizontal direction (Y-axis direction), but the number and arrangement of the aligners 120 are not limited thereto and may be freely selected. The pre-wet module 200 replaces air inside a pattern formed on a surface of the substrate with a processing liquid such as pure water or degassed water, by wetting a plating-target surface of the substrate before plating processing. The pre-wet module 200 can perform pre-wet processing to facilitate supplying a plating solution inside the pattern by replacing the processing liquid inside the pattern with the plating solution (electrolyte solution) during plating. In the present embodiment, two pre-wet modules 200 are disposed side by side along a vertical direction (Z-axis direction), but the number and arrangement of the pre-wet modules 200 are not limited thereto and may be freely selected.

For example, the pre-soak module 300 performs pre-soak processing of etching and removing an oxide film with high electrical resistance present on a surface such as a surface of a seed layer formed on the plating-target surface of the substrate before the plating processing by using a processing liquid such as sulfuric acid or hydrochloric acid, and of cleaning or activating an underlying plating surface. In the present embodiment, two pre-soak modules 300 are disposed side by side along the vertical direction (Z-axis direction), but the number and arrangement of the pre-soak modules 300 are not limited thereto and may be freely selected.

The plating module 400 performs plating processing on the substrate. In the present embodiment, a total of 24 plating modules 400 are arranged. Specifically, twelve plating modules 400 are disposed in a matrix of three rows in the vertical direction (Z-axis direction) and four columns in the horizontal direction (Y-axis direction) on one side of the plating apparatus 1000, and twelve plating modules 400 are disposed in a matrix of three rows in the vertical direction (Z-axis direction) and four columns in the horizontal direction (Y-axis direction) on the other side of the plating apparatus 1000. However, the number and arrangement of the plating modules 400 is not limited thereto and may be freely selected. A specific configuration example of the plating module 400 will be described below.

The cleaning module 500 performs cleaning processing on the substrate for removing unnecessary residue such as plating solution remaining on the substrate after the plating processing. In the present embodiment, two cleaning modules 500 are disposed side by side along the vertical direction (Z-axis direction), but the number and arrangement of the cleaning modules 500 are not limited thereto and may be freely selected. The spin rinse dryer 600 is a module for drying the substrate by rotating the substrate at a high speed after the cleaning processing. In the present embodiment, two spin rinse dryers 600 are disposed side by side along the vertical direction (Z-axis direction), but the number and arrangement of the spin rinse dryers 600 are not limited thereto and may be freely selected. The transfer device 700 is a device for transferring the substrate between the plurality of modules within the plating apparatus 1000.

The control module 800 controls operations and states of the plurality of modules in the plating apparatus 1000. For example, the control module 800 may be implemented as a computer operable by an operator, and it is desirable that the control module 800 includes user interface equipment such as a pointing device and a key input device so that the operator can input information.

Such a control module 800 may be achieved by one computer including one or more processors, or may be achieved by a plurality of computers connected to each other via a communication path. All or part of constituent elements of the control module 800 may be achieved by one or more processors including one or more computation apparatuses (processing units) that execute processing through software or firmware code (plurality of instructions) read from a non-volatile memory (computer-readable recording medium). For example, a CPU, a GPU, or an NPU can be used as the computation apparatus. GPUs and NPUs are computation apparatuses designed to have a structure suitable for computation (for example, tensor computation) based on artificial neural network, that is, a neural network model. Alternatively, all or part of the constituent elements of a control module 800 can be achieved by one or more processors having a semiconductor integrated circuit such as an FPGA. Alternatively, all or part of the constituent elements of the control module 800 may be achieved by one or more processors including a combination of a semiconductor integrated circuit such as an FPGA and computation apparatus such as a CPU or a GPU.

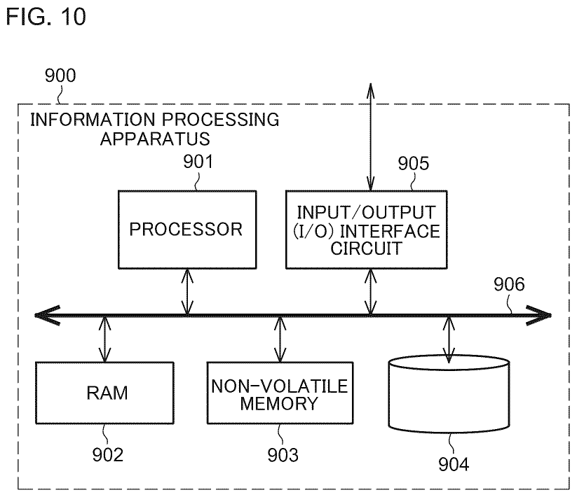

FIG. 10 is a schematic configuration diagram of an information processing apparatus (computer) 900 being a hardware configuration example for realizing the control module 800. The information processing apparatus 900 includes a processor 901, a random access memory (RAM) 902, a non-volatile memory 903, a large-capacity storage 904, an input/output (I/O) interface circuit 905, and a signal path 906. The signal path 906 is a bus for connecting the processor 901, the RAM 902, the non-volatile memory 903, the storage 904, and the input/output (I/O) interface circuit 905 to each other. The RAM 902 is a data storage region used when the processor 901 executes digital signal processing. When a computation apparatus such as a CPU or a GPU is incorporated in the processor 901, the non-volatile memory 903 can have a data storage region in which software code executed by the processor 901 is stored. For example, the input/output (I/O) interface circuit 905 can be connected to user interface equipment (not shown).

Next, an example of a series of plating processing by the plating apparatus 1000 will be described.

First, a substrate accommodated in a cassette is loaded into the load port 100. Subsequently, the transfer robot 110 takes the substrate out of the cassette of the load port 100 and transfers the substrate to the aligner 120. The aligner 120 aligns a position of an orientation flat, a notch, and the like of the substrate in a predetermined direction. The transfer robot 110 hands over the substrate whose direction has been aligned by the aligner 120 to the transfer device 700.

The transfer device 700 transfers the substrate received from the transfer robot 110 to the pre-wet module 200. The pre-wet module 200 performs pre-wet processing on the substrate. The transfer device 700 transports the substrate on which the pre-wet processing has been performed to the pre-soak module 300. The pre-soak module 300 performs pre-soak processing on the substrate. The transfer device 700 transfers the substrate on which the pre-soak processing has been performed to the plating module 400. The plating module 400 performs plating processing on the substrate.

The transfer device 700 transports the substrate on which the plating processing has been performed to the cleaning module 500. The cleaning module 500 performs cleaning processing on the substrate. The transfer device 700 transfers the substrate on which the cleaning processing has been performed to the spin rinse dryer 600. The spin rinse dryer 600 performs drying processing on the substrate. The transfer device 700 hands over the substrate on which the drying processing has been performed to the transfer robot 110. The transfer robot 110 transfers the substrate received from the transfer device 700 to the cassette of the load port 100. Finally, the cassette accommodating the substrate is unloaded from the load port 100.

Note that the configuration of the plating apparatus 1000 described with reference to FIGS. 8 and 9 is merely an example, and the configuration of the plating apparatus 1000 is not limited to the above configuration.

Next, a configuration example of the plating module 400 will be described.

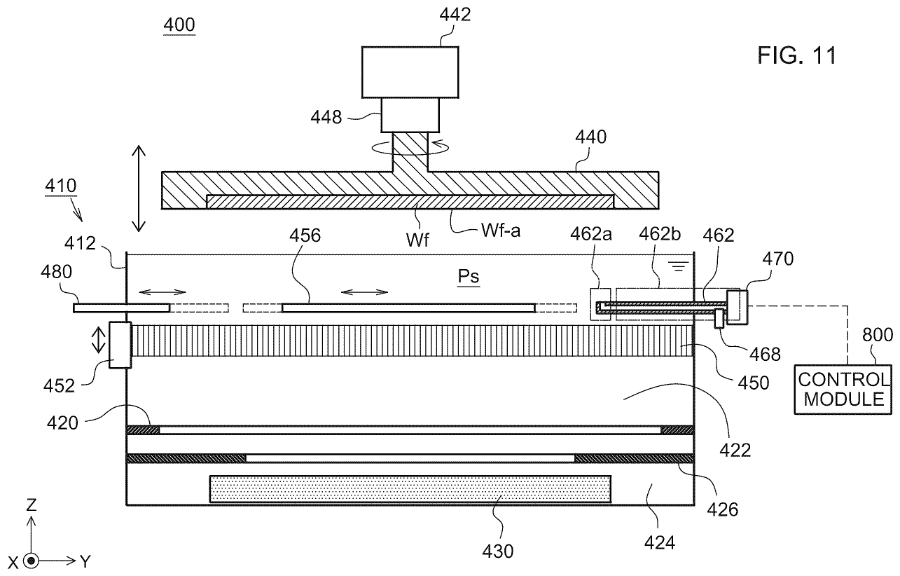

Since the 24 plating modules 400 in the present embodiment have the same configuration, only one plating module 400 will be described. FIG. 11 is a cross-sectional view schematically showing the configuration of the plating module 400 of the third embodiment. As shown in FIG. 11, the plating module 400 includes a plating bath 410 for accommodating the plating solution Ps. The plating bath 410 includes a cylindrical inner tank 412 having an upper surface that is open, and an outer tank (not shown) provided around the inner tank 412 so as to collect plating solution that overflows from an upper edge of the inner tank 412.

The plating module 400 includes a substrate holder 440 for holding the substrate Wf having a plating-target surface Wf-a. As shown in FIG. 11, the substrate holder 440 grips a peripheral portion of the substrate Wf in a state in which the plating-target surface Wf-a is directed toward an opening of the plating bath 410. The plating module 400 includes a lifting mechanism 442 for moving the substrate holder 440 up and down in the Z-axis direction. In one embodiment, the plating module 400 includes a rotation mechanism 448 that causes the substrate holder 440 to rotate about a vertical axis. The lifting mechanism 442 and the rotation mechanism 448 can be achieved by a known mechanism such as a motor. During the plating processing, the lifting mechanism 442 lowers the substrate holder 440 and immerses the plating-target surface Wf-a of the substrate Wf in the plating solution Ps.

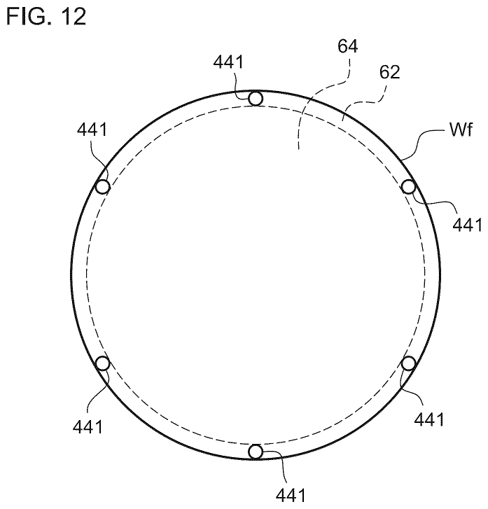

The substrate holder 440 includes one or more power supply electrical contacts for supplying power from a power supply (not shown) to the substrate Wf in a state in which the plating-target surface Wf-a is immersed in the plating solution Ps. FIG. 12 is a schematic plan view of the substrate Wf. The peripheral portion 62 of the substrate Wf is also a portion at which the substrate Wf is gripped by the substrate holder 440. In the example of FIG. 12, the peripheral portion 62 of the substrate Wf has six electrical contacts 441 at equal intervals along a circumferential direction of the substrate Wf, but the number of the electrical contacts 441 is not limited to six. The electrical contacts 441 are connected to a negative terminal of the power supply via electrical wiring (not shown) incorporated embedded inside the substrate holder 440, and a plating current can be supplied to the substrate Wf through the electrical contacts 441. As described below, the control module 800 can calculate the current density distribution of a plating current at the inner region 64 of the substrate Wf located inward of the peripheral portion 62 of the substrate Wf, based on the state estimate representing the current density in the vicinity of the peripheral portion 62 of the substrate Wf.

Referring to FIG. 11, the plating module 400 includes an anode 430 provided on a bottom surface of the inner tank 412. The anode 430 is disposed in the inner tank 412 so as to be opposite the plating-target surface Wf-a of the substrate Wf held by the substrate holder 440. The plating module 400 includes a membrane 420 that separates an internal region of the inner tank 412 into an upper region and a lower region. That is, the inner region of the inner tank 412 is divided by the membrane 420 into a cathode region 422 comparatively close to the plating-target surface Wf-a and an anode region 424 comparatively close to the anode 430. The cathode region 422 and the anode region 424 are each filled with the plating solution Ps. Note that the present embodiment shows an example in which the membrane 420 is provided, but a form in which the membrane 420 is not provided is also possible.

An anode mask 426 for adjusting electrolytic conditions between the anode 430 and the substrate Wf is disposed in the anode region 424. The anode mask 426 is, for example, a substantially plate-like member made of a dielectric material, and is provided facing (or above) the anode 430. The anode mask 426 has an opening through which the current flowing between the anode 430 and the substrate Wf passes. In the present embodiment, the anode mask 426 is configured such that an opening dimension can be changed, and this opening dimension can be adjusted by the control module 800. Here, the opening dimension means a diameter when the opening is circular, and a length of one side or a longest opening width when the opening is polygonal. Note that a known mechanism can be adopted as a means of changing the opening dimension of the anode mask 426. The present embodiment shows an example in which the anode mask 426 is provided, but a form in which the anode mask 426 is not provided is also possible. In the example of FIG. 11, the membrane 420 and the anode mask 426 are provided spatially separated, but the membrane 420 may be provided in the opening of the anode mask 426 instead.

A resistor 450 opposite the membrane 420 is disposed in the cathode region 422. The resistor 450 is a member for achieving uniformity of the plating processing at the plating-target surface Wf-a of the substrate Wf In the present embodiment, the resistor 450 is movable in the vertical direction (Z-axis direction) in the plating bath 410 by a driving mechanism 452, and a position of the resistor 450 can be adjusted by the control module 800. However, a form in which the resistor 450 is not provided in the plating module 400 is also possible. A specific material of the resistor 450 is not particularly limited, but a porous resin such as polyether ether ketone can be used as an example of the material of the resistor 450.

A paddle 456 for stirring the plating solution Ps is provided in a region close to the surface of the substrate Wf in the cathode region 422. The paddle 456 can be made of, for example, titanium (Ti) or resin. The paddle 456 stirs the plating solution so that sufficient metal ions are uniformly supplied to the plating-target surface Wf-a during plating of the substrate W, by reciprocating in a direction parallel to the plating-target surface Wf-a of the substrate Wf. The paddle 456 may, for example, move in a direction perpendicular to the plating-target surface Wf-a of the substrate Wf instead. Note that a form in which the paddle 456 is not provided in the plating module 400 is also possible.

A conduit 462 is disposed in the cathode region 422. The conduit 462 is a hollow tube, and can be formed from a resin such as polypropylene (PP) or polyvinyl chloride (PVC). When the resistor 450 is provided in the cathode region 422, the conduit 462 is provided between the substrate Wf and the resistor 450. When the paddle 456 is provided, the conduit 462 is disposed so as not to interfere with the paddle 456. For example, the conduit 462 is preferably disposed at the same height position (the same position in the Z-axis direction) as the paddle 456 and at a position outward of the paddle 456 (in FIG. 11, horizontally outward position).

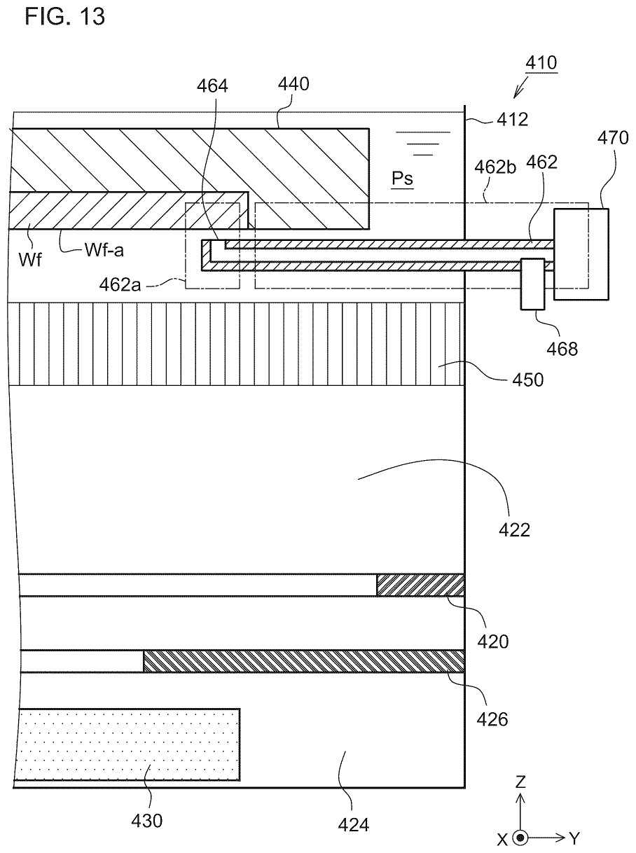

FIG. 13 is an enlarged view of a surrounding region of the conduit 462 in the plating module 400 of the third embodiment. FIG. 13 shows the state in which the substrate holder 440 has descended inside the plating bath 410 and is immersed in the plating solution Ps. As shown in FIGS. 11 and 13, the conduit 462 has an opening end 464 disposed in a region between the substrate Wf and the anode 430. This opening end 464 is positioned between the substrate Wf and the anode 430 in the direction perpendicular to the plating-target surface Wf-a of the substrate Wf (Z-axis direction), and is disposed at a position overlapping with the substrate Wf when viewed from this perpendicular direction. The opening end 464 is preferably disposed in a vicinity of the plating-target surface Wf-a and is opposite the plating-target surface Wf-a. As an example, a distance between the opening end 464 and the plating-target surface Wf-a is several hundred micrometers, several millimeters, or several tens of millimeters. Note that in the examples of FIGS. 11 and 13, the opening end 464 opens in a direction opposite the plating-target surface Wf-a (Z-axis direction), but the present invention is not limited thereto. The opening end 464 may open in a direction perpendicular to a direction in which the substrate Wf and the anode 430 are connected (negative Y-axis direction), or may open in a direction inclined with respect to a normal direction of the plating-target surface Wf-a of the substrate Wf.

In the present embodiment, the conduit 462 extends from the region between the substrate Wf and the anode 430 to a region away from the region between the substrate Wf and the anode 430, and extends outside of the plating bath 410. Hereinafter, as shown in FIGS. 11 and 13, a portion of the conduit 462 disposed in the region between the substrate Wf and the anode 430 is referred to as a “first portion 462a”, and a portion of the conduit 462 disposed in the region away from the region between the substrate Wf and the anode 430 is referred to as a “second portion 462b”. The conduit 462 preferably extends in a direction (Y-axis direction) perpendicular to the direction (Z-axis direction) in which the substrate Wf and the anode 430 are connected. However, the present invention is not limited to such an example, and the conduit 462 may extend in any direction.

An inside of the conduit 462 is filled with the plating solution similar to the cathode region 422. A filling mechanism 468 for filling the conduit 462 with the plating solution may be provided in the conduit 462. Various known mechanisms can be adopted as the filling mechanism 468, and an air vent valve or a mechanism for supplying the plating solution can be adopted as an example. The filling mechanism 468 is provided in the second portion 462b of the conduit 462 as an example.

Note that in FIGS. 11 and 13, one conduit 462 is shown. for clarity, but a plurality of conduits may be provided in the plating bath 410 instead. When the plurality of conduits is provided, an opening end of each conduit may be disposed at different distances from a center of the substrate Wf. When the plurality of conduits are provided, the opening end of each conduit is preferably disposed at a position in which a distance from the plating-target surface Wf-a of the substrate Wf is equal.

A potential sensor 470 is provided at the second portion 462b of the conduit 462. Note that the potential sensor 470 is disposed outside of the plating bath 410 in FIGS. 11 and 13, but may be arranged inside the plating bath 410 instead. The potential sensor 470 has a function of detecting or measuring the potential of the plating solution Ps with which the conduit 462 has been filled. Here, the plating solution Ps in the conduit 462 has substantially the same potential as the plating solution in a vicinity of the opening end 464, and a potential detected by the potential sensor 470 is approximately equal to the potential of the plating solution Ps in the vicinity of the opening end 462a. Thus, the vicinity of the opening end 464 can be set as a pseudo potential detection position for the potential sensor 470, and the potential in the vicinity of the plating-target surface Wf-a can be measured by the potential sensor 470 provided in the second portion 462b of the conduit 462. The potential sensor 470 supplies a measurement signal representing the measured potential to the control module 800.

In one embodiment, a reference potential sensor (not shown) may be provided at a location in the plating bath 410 where a potential change is comparatively small, and a difference between the potential detected by the reference potential sensor and the potential detected by the potential sensor 470 is preferably acquired. The change in the potential measured by the potential sensor 470 is exceedingly small and is therefore easily affected by noise. In order to reduce noise, an independent electrode is preferably installed in the plating solution and directly connected to ground.

The control module 800 has a function of estimating a film thickness distribution of a plating film formed on the substrate Wf, based on the measurement signal representing the potential measured by the potential sensor 470. The control module 800 may detect an endpoint of the plating processing or may predict an amount of time until the endpoint of the plating processing, based on the measurement signal. As an example, the control module 800 may end the plating processing when a film thickness of the plating film reaches a desired thickness, based on the measurement signal. As an example, the control module 800 may calculate a film thickness increase rate of the plating film based on the measurement signal, and predict an amount of time until the plating film reaches the desired thickness, in other words, the amount of time until the endpoint of the plating processing.

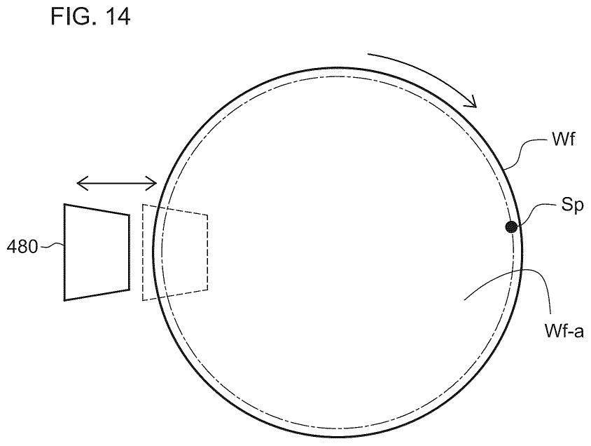

Returning to FIG. 11, in one embodiment, a shield 480 for partially blocking an amount of current flowing from the anode 430 to the substrate Wf is provided in the cathode region 422. The shield 480 is, for example, a substantially plate-like member made of a dielectric material. FIG. 14 is a schematic diagram of the shield 480 and the substrate Wf of the present embodiment as viewed from below (negative Z-axis direction). Note that in FIG. 14, the substrate holder 440 that holds the substrate Wf is omitted. The shield 480 is movable to any position between a shielding position (position indicated by dashed line in FIG. 14) interposed between the plating-target surface Wf-a of the substrate Wf and the anode 430, and a retracted position (position indicated by solid line in FIG. 14) at which the shield 480 is retracted from between the plating-target surface Wf-a and the anode 430. In other words, the shield 480 is movable between the shielding position directly below the plating-target surface Wf-a and the retracted position away from directly below the plating-target surface Wf-a. The position of the shield 480 is controlled by the control module 800 via a driving mechanism (not shown). The movement of the shield 480 can be achieved by a known mechanism such as a motor or a solenoid. In the example of FIG. 14, the shield 480 blocks part of an outer circumferential region of the plating-target surface Wf-a of the substrate Wf in the circumferential direction at the shielding position. In the example of FIG. 14, the shield 480 is formed in a tapered shape that narrows toward the center of the substrate Wf. However, the present invention is not limited to such examples, and a member of any shape determined in advance through experiments or the like can be used as the shield 480.

Next, the plating processing in the plating module 400 of the present embodiment will be described in more detail.

The substrate Wf is exposed to the plating solution by immersing the substrate into the plating solution of the cathode region 422 by using the lifting mechanism 442. The plating module 400 can perform the plating processing on the plating-target surface Wf-a of the substrate Wf by applying a voltage between the anode 430 and the substrate Wf in this state. In one embodiment, the plating processing is performed while rotating the substrate holder 440 by using the rotation mechanism 448. A conductive film (plating film) is deposited on the plating-target surface Wf-a of the substrate Wf through the plating processing. In the present embodiment, during the plating processing, the potential sensor 470 detects or measures in real-time the potential of the plating solution in the vicinity of the peripheral portion of the substrate Wf (for example, at a predetermined detection point Sp shown in FIG. 7). The control module 800 can measure the film thickness of the plating film in real-time, based on the measurement signal representing the potential measured by the potential sensor 470. This allows the film thickness distribution of the plating film formed on the plating-target surface Wf-a of the substrate Wf during the plating processing to be measured and monitored in real-time.

By detecting the potential with the potential sensor 470 accompanying the rotation of the substrate holder 440 (rotation of the substrate Wf), the position detected by the potential sensor 470 can be changed, and the film thickness at a plurality of points in the circumferential direction of the substrate Wf or the entire circumferential direction can be measured.

Note that the plating module 400 may change the rotation speed of the substrate Wf during the plating processing by using the rotation mechanism 448. As an example, the plating module 400 may slowly rotate the substrate Wf for estimating the plating film thickness by using the film thickness estimation function of the control module 800. As an example, the plating module 400 may rotate the substrate Wf at a first rotation speed Rs1 during the plating processing, and the substrate Wf may be rotated at a second rotation speed Rs2 slower than the first rotation speed Rs1 at intervals (for example, every few seconds) while the substrate Wf rotates once or several times. By doing so, even when a sampling period by the potential sensor 470 is short relative to the rotation speed of the substrate Wf, the plating film thickness of the substrate Wf can especially be estimated with precision. Here, the second rotation speed Rs2 may be a tenth of the first rotation speed Rs1.

Data of a change in the film thickness of the plating film measured by using film thickness measurement function of the control module 800 is recorded. In subsequent plating processing, the plating conditions including at least one of the plating current value, the plating time, the opening dimension of the anode mask 426, or the position of the shield 480 can be adjusted with reference to such data. Note that the adjustment of the plating conditions may be performed by a user of the plating apparatus 1000 or through a function of the control module 800. As an example, the adjustment of the plating conditions by the control module 800 may be performed based on a conditional expression determined in advance through experiments, a program, or the like.

The adjustment of the plating conditions may be performed when plating another substrate Wf, or the adjustment of the plating conditions in the current plating processing may be executed in real-time. As an example, the control module 800 may change the plating conditions by adjusting the position of the shield 480.

The control module 800 may adjust the plating conditions in real-time by driving the lifting mechanism 442 or the driving mechanism 452 and adjusting a distance between the substrate Wf and the resistor 450. The distance between the substrate Wf and the resistor 450 comparatively affects the amount of plating formed in a vicinity of an outer circumferential portion of the substrate Wf, while the distance may not comparatively affect the amount of plating formed near the center of the substrate Wf Therefore, as an example, the control module 800 can perform control such that the distance between the substrate Wf and the resistor 450 is reduced when the film thickness of the plating film in the vicinity of the outer circumferential portion of the substrate Wf is greater than a target, and the distance between the substrate Wf and the resistor 450 is increased when the film thickness of the plating film in the vicinity of the outer circumferential portion is smaller than the target. The control module 800 can also perform control such that the distance between the substrate Wf and the resistor 450 increases the longer the shield 480 is in the shielding position, and the distance between the substrate Wf and the resistor 450 decreases the shorter the shield 480 is in the shielding position. By doing so, the amount of plating formed in the vicinity of the outer circumferential portion of the substrate Wf can be adjusted and the uniformity of the plating film formed over the entire substrate Wf can be enhanced.

Furthermore, the control module 800 may adjust the plating conditions in real-time by adjusting the opening dimension of the anode mask 426. As an example, the control module 800 may execute control such that the opening dimension of the anode mask 426 is reduced when the film thickness of the plating film in the vicinity of the outer circumferential portion of the substrate Wf is greater than a target, and the opening dimension of the anode mask 426 is increased when the film thickness of the plating film in the vicinity of the outer circumferential portion is smaller than the target.

Next, a configuration of the control module 800 in the present embodiment will be described in detail below.

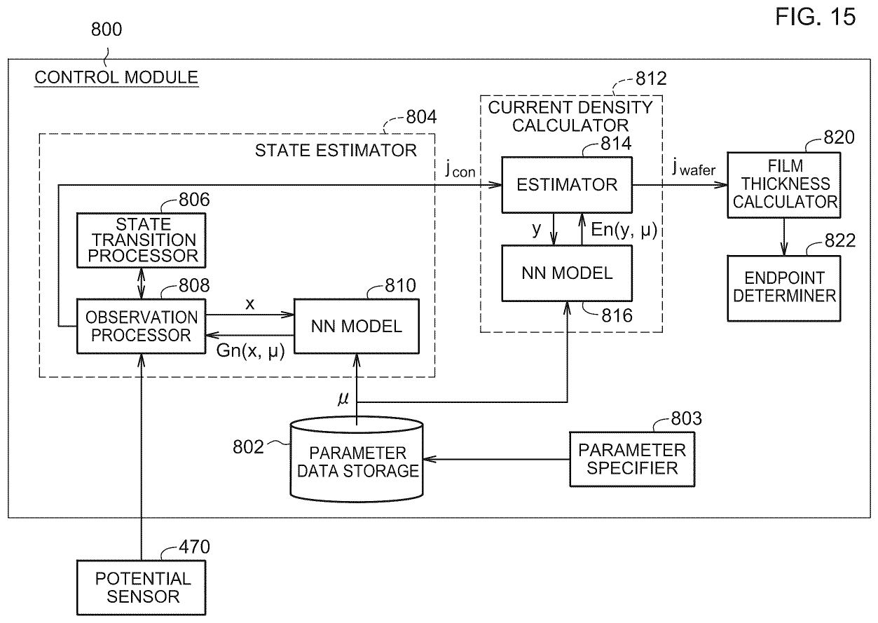

FIG. 15 is a functional block diagram showing a schematic configuration of the control module 800 in the third embodiment. FIG. 15 shows only functional blocks related to the measurement of the film thickness distribution of the plating film among various functions of the control module 800. As shown in FIG. 15, the control module 800 includes a parameter data storage 802, a parameter specifier 803, a state estimator 804, a current density calculator 812, a film thickness calculator 820, and an endpoint determiner 822.

As described above, the potential sensor 470 measures the potential of the plating solution Ps in the vicinity of the peripheral portion of the substrate Wf held by the substrate holder 440 during the plating processing. The potential sensor 470 outputs the measurement signal representing the measured potential to the state estimator 804. The state estimator 804 can calculate, using a measured potential quantity expressed by the measurement signal as input, a state estimate representing a current density j_{con} at the peripheral portion of the substrate Wf, based on a state space model expressed by the observation model and the state transition model. For convenience of description, the current density at the peripheral portion of the substrate Wf may be hereinafter referred to as “peripheral portion current density”. As shown in FIG. 15, the state estimator 804 includes a state transition processor 806 that performs computation based on the state transition model, a neural network model (NN model) 810, and an observation processor 808 that performs computation based on an observation model by using the NN model 810. The NN model 810 has the same structure and parameter group as the NN model 809 according to the first embodiment. This NN model 810 may be achieved by a computer program, or by a hardware configuration such as semiconductor integrated circuit.

The state transition processor 806 and the observation processor 808 can calculate the state estimate representing the peripheral portion current density j_{con} by cooperating with each other and executing state estimation processing using a Kalman filter, based on the input measured potential quantity. The measured potential quantity at each time may be a scalar quantity representing the potential at one point on the peripheral portion of the substrate Wf, or may be a vector quantity representing the potential at a plurality of points on the peripheral portion of the substrate Wf.

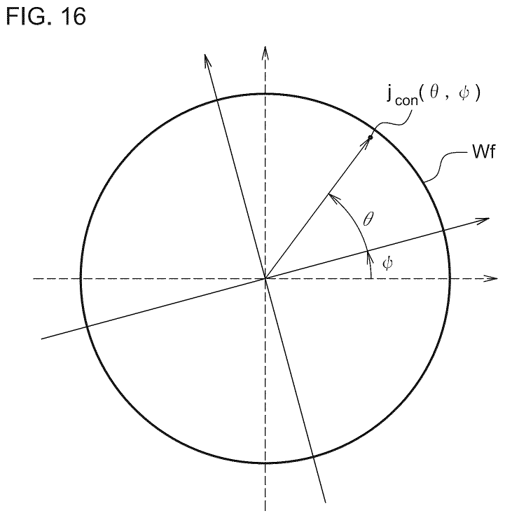

A position on the peripheral portion of the substrate Wf is represented by a pair (θ,ψ) of a rotation angle θ with respect to an electrical contact of the substrate Wf and a rotation angle ψ of the substrate holder 440. FIG. 16 is a diagram for describing the current density j_{con}(θ,ψ) at the position (θ,ψ) in the peripheral portion of the substrate Wf. The peripheral portion current density j_{con}(θ, ψ) is expressed by the following equation (9) using a Fourier series expansion.

$$\begin{matrix}{j}_{con} ( θ , ψ ) = {a}_{0} + {\sum }_{i = 1}^{n} ( {a}_{i} cos i ( θ - ψ ) + {b}_{i} sin i ( θ - ψ ) ) \\ = {a}_{0} + {\sum }_{i = 1}^{n} ( \begin{matrix}{a}_{i} & {b}_{i}\end{matrix} ) ( \begin{matrix}cos i ψ & sin i ψ \\ - sin i ψ & cos i ψ\end{matrix} ) ( \begin{matrix}cos i θ \\ sin i θ\end{matrix} ) \\ = {a}_{0} + {\sum }_{i = 1}^{n} ( \begin{matrix}{a}_{i} & {b}_{i}\end{matrix} ) {R}_{i} ( ψ ) ( \begin{matrix}cos i θ \\ sin i θ\end{matrix} )\end{matrix} \qquad ( 9 )$$

In this equation, aᵢ and bᵢ (where i is an integer within a range of 0 to n, and n is a positive integer) are Fourier coefficients, and Rᵢ(ψ) is a rotation matrix. The set of Fourier coefficients {aᵢ,bᵢ} can express the peripheral portion current density j_{con}(θ,ψ). The set {aᵢ,bᵢ} is a state variable and can, for example, be expressed in the form of a state vector.

The state transition model is a model that describes a temporal transition of the state variable representing the peripheral portion current density j_{con}. For example, the state transition model that describes a relationship between a state variable at time t and a state variable at time t−1 can be expressed in the form of the following state equation (10) using a state transition function Fᵢ.

$$( \begin{matrix}{a}_{i , t} \\ {b}_{i , t}\end{matrix} ) = {F}_{i} ( \begin{matrix}{a}_{i , t - 1} \\ {b}_{i , t - 1}\end{matrix} ) + {v}_{t - 1} \qquad ( 10 )$$

In this equation, a_{i,t} and b_{i,t} are Fourier coefficients at time t, a_{i,t-1} and b_{i,t-1} are Fourier coefficients at time t−1, and vₜ₋₁ is noise.

The state transition function Fᵢ may be expressed by a linear operator such as a matrix. The state transition function Fᵢ in matrix form is, for example, expressed by the following equations (11) and (12).

$${F}_{i} = \frac{1}{1 + {c}_{i}^{2}} ( \begin{matrix}1 - {c}_{i}^{2} & - 2 {c}_{i} \\ 2 {c}_{i} & 1 - {c}_{i}^{2}\end{matrix} ) \qquad ( 11 )$$

$${c}_{i} = \frac{i ω Δ t}{2} \qquad ( 12 )$$

In these equations, ω is an angular velocity of the rotation of the substrate Wf, and Δt is a time step (that is, a time difference between time t and time t−1). Note that the state equation is not limited to the mathematical expressions expressed by equations (10) to (12). Any state equation can be used provided the state equation can be applied to state estimation processing using a Kalman filter.

In the state estimation processing using the Kalman filter, the state transition processor 806 calculates prior information corresponding to a prior distribution in a Bayesian estimation, based on a predetermined update equation based on the state transition model. For example, the prior information includes a prior state estimate and a prior error covariance matrix.

On the other hand, the observation model is a model that describes a relationship between the measured potential quantity (that is, a sensor observation) and the state variable representing the peripheral portion current density j_{con}. For example, the observation model can be expressed as an observation equation that describes a relationship between a measured potential quantity φₜ at time t and a state variable quantity xₜ representing the peripheral portion current density j_{con} at time t. The observation equation can be expressed in the form of the following equation (13) by using an observation function Gₜ at time t.

$${ϕ}_{t} = {G}_{t} ( \begin{matrix}{a}_{1 , t} \\ {b}_{1 , t} \\ ⋮ \\ {a}_{n , t} \\ {b}_{n , t}\end{matrix} ) + {w}_{t} = {G}_{t} ( {x}_{t} ) + {w}_{t} \qquad ( 13 )$$

In this equation, the observation function Gₜ is a response quantity of the potential sensor 470 with respect to the peripheral portion current density j_{con}, and wₜ is noise.

In the state estimation processing using the Kalman filter, the observation processor 808 calculates posterior information corresponding to a posterior distribution in a Bayesian estimation, based on a predetermined update equation that is based on the observation model, the measured potential quantity, and the prior information each time the measured potential quantity is given. For example, the posterior information includes a posterior state estimate and a posterior error covariance matrix. The posterior state estimate is an estimate of a state at the current time t updated using an actual measured potential quantity and the prior information. The observation processor 808 can output, to the current density calculator 812, the calculated posterior state estimate as a state estimate representing the peripheral portion current density j_{con}.

The NN model 810 can be trained so as to output an estimate (potential estimate) representing the potential of the plating solution Ps in the vicinity of the peripheral portion of the substrate Wf, when the state variable representing the peripheral portion current density j_{con} and the parameter data μ that defines the plating conditions are input. The parameter data μ that defines the plating conditions will be described below.

The observation processor 808 can use the NN model 810 as the observation function Gₜ, when executing computation based on the observation function Gₜ in the state estimation processing using the Kalman filter. Specifically, when using the NN model 810 as the observation function Gₜ, the observation processor 808 calls the NN model 810 and inputs a variable x to the NN model 810, as shown in FIG. 15. The NN model 810 outputs an inference result Gn(x,μ) in accordance with the input variable x and parameter data μ.

Parameters of the plating processing relating to at least one constituent element of the plating module 400 (for example, the plating solution Ps, the plating bath 410, the substrate holder 440, and the anode 430) are stored in the parameter data storage 802. The parameters are data that defines conditions of a forming process of the plating film (that is, the plating conditions). Examples of the parameter data include the position and the orientation of the substrate holder 440, the rotation speed of the substrate Wf by the rotation mechanism 448, the type of the plating solution, the electrical conductivity of the plating solution, the polarization gradient, the plating current value, the plating time, the opening dimension of the anode mask 426, the position of the shield 480, and the distance between the substrate Wf and the resistor 450, but the present invention is not limited thereto.

In response to an instruction from the parameter specifier 803, the parameter data storage 802 selects a parameter specified by the instruction from among the parameters stored in the parameter data storage 802, and inputs the parameter data μ indicating a value of the selected parameter to the NN model 810. The parameter specifier 803 has a function of providing, to the parameter data storage 802, an instruction corresponding to information input by the operator through the user interface equipment. As described above, the control module 800 has a control function of adjusting the plating conditions during the plating processing in accordance with the film thickness distribution of the plating film that is measured or estimated. The parameter specifier 803 can provide, to the parameter data storage 802, an instruction specifying the parameters that define the plating conditions adjusted by this control function.

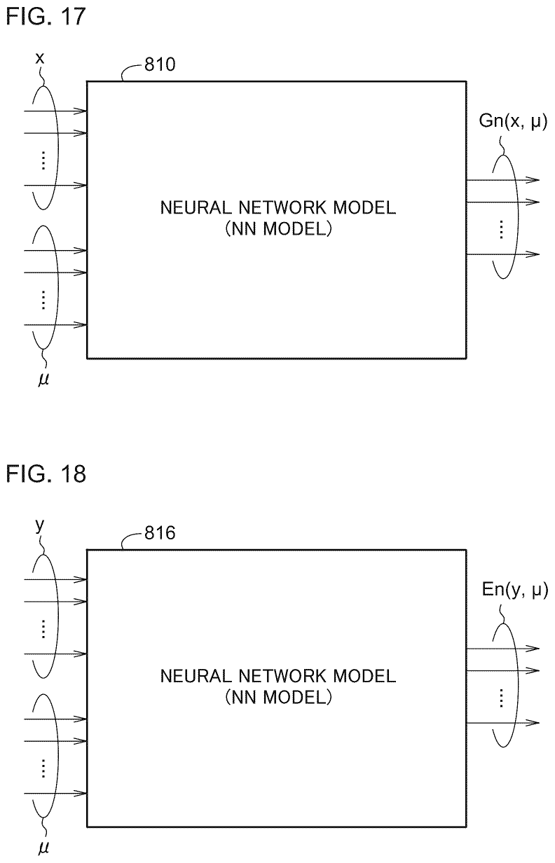

FIG. 17 is a diagram showing a schematic configuration of the NN model 810 of the present embodiment. As shown in FIG. 17, the NN model 810 accepts the parameter data μ provided from the parameter data storage 802 and the state variable x, executes inference computation based on the input state variable x and parameter data μ, and outputs the inference result Gn(x,μ).

Next, referring to FIG. 15, the current density calculator 812 receives supply of the state estimate representing the peripheral portion current density ji calculated by the state estimator 804. The current density calculator 812 calculates, from the state estimate, a current density j_{wafer} in the inner region 64 (FIG. 12) of the substrate Wf located inward of the peripheral portion 62 of the substrate Wf. For convenience of description, the current density in the inner region 64 may be hereinafter referred to as “plating current density”. Specifically, the current density calculator 812 includes an estimator 814 and a neural network model (NN model) 816 as a second trained neural network model (NN model). The NN model 816 has the same structure and parameter group as the NN model 815 according to the second embodiment.

The estimator 814 calculates, from the state estimate, the plating current density j_{wafer} by using the NN model 816. The NN model 816 may be achieved by a computer program, or by a hardware configuration such as semiconductor integrated circuit.

The NN model 816 outputs an inference result En(y,μ) representing the plating current density j_{wafer}, when a state variable y representing the peripheral portion current density j_{con} and the parameter data μ that defines the plating conditions are input. As shown in FIG. 15, the estimator 814 calls the NN model 816 and inputs the variable y to the NN model 814. The NN model 816 outputs the inference result En(y,μ) in accordance with the input variable x and parameter data μ. The estimator 814 can output the inference result En(y,μ) as the estimated plating current density j_{wafer} to the film thickness calculator 820.

FIG. 18 is a diagram showing a schematic configuration of the NN model 816 of the present embodiment. As shown in FIG. 18, the NN model 816 accepts the parameter data μ provided from the parameter data storage 802 and the state variable y, executes inference computation based on the input state variable y and parameter data μ, and outputs the inference result En(y,μ).

Next, referring to FIG. 15, the film thickness calculator 820 calculates the film thickness distribution of the plating film formed on the substrate Wf, based on a plating current density j_{wafer}(k,t) obtained from the current density calculator 812. Here, t is the current time, and k is a number indicating the position of the inner region 64 on the substrate Wf In one embodiment, the film thickness calculator 820 can calculate a deposition rate v(k,t) and a film thickness distribution w(k,t) of the plating film at a position k on the substrate Wf and at the current time t by using the following equations (14) and (15).

$$v ( k , t ) = \frac{M}{zF ρ} {j}_{wafer} ( k , t ) \qquad ( 14 )$$

$$w ( k , t ) = {\sum }_{q = 0}^{t} v ( k , q ) Δ t \qquad ( 15 )$$

In these equations, M is a molecular weight of the plating deposited on the substrate Wf, ρ is a density of the plating deposited on the substrate Wf, z is a valence of a plating reaction, and F is the Faraday constant. Note that the film thickness calculator 820 may calculate a film thickness w(k,T) at an end time of the plating processing (time q=T) instead of the current film thickness distribution w(k,t), by predicting a future plating current density and deposition rate using the above state equation.

The endpoint determiner 822 determines an endpoint of the plating processing for the substrate Wf, based on the film thickness distribution w(k,t) of the plating film obtained by the film thickness calculator 820. For example, the endpoint determiner 822 may end the plating processing when the estimated current film thickness distribution w(k,t) reaches a desired thickness distribution, or may predict the time to the endpoint of the plating processing based on the estimated current film thickness w(k,t) and the predicted future deposition rate v(k,s) (s=t, . . . , T).

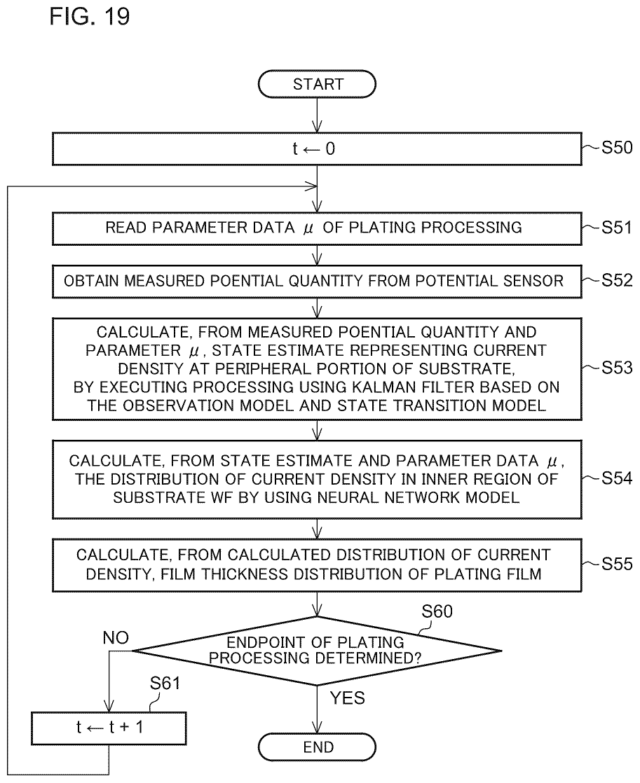

Next, a processing procedure by the above control module 800 will be described hereinafter. FIG. 19 is a flowchart showing an example of a processing procedure for calculating the film thickness distribution of the plating film.

Referring to FIG. 19, the state estimator 804 first initializes time t (step S50). Subsequently, the state estimator 804 reads the parameter data μ supplied from the parameter data storage 802 (step S51), and then obtains the measured potential quantity from the potential sensor 470 (step S52). Here, an order of steps S51 and S52 may be reversed.

Subsequently, the state estimator 804 calculates, from the measured potential quantity and parameter μ, the state estimate representing the current density j_{con} at the peripheral portion of the substrate Wf, by executing the state estimation processing using the Kalman filter based on the observation model and the state transition model (step S53). At this time, the computation based on the observation model is performed using the NN model 810.

Next, the current density calculator 812 calculates, from the state estimate and the parameter data ρ, the distribution of the current density (plating current density) j_{wafer} in the inner region of the substrate Wf by using the NN model 816 (step S54). Next, the film thickness calculator 820 calculates the film thickness distribution w(k,t) of the plating film formed on the substrate Wf, based on the plating current density j_{wafer} obtained from the current density calculator 812 (step S55). As described above, the endpoint determiner 822 determines the endpoint of the plating processing for the substrate Wf has been detected, based on the film thickness distribution w(k,t) of the plating film obtained by the film thickness calculator 820 (step S60). Upon determining that the endpoint of the plating processing has been detected (YES in step S60), the control module 800 ends the plating processing. On the other hand, when the endpoint of the plating processing is not detected (NO in step S60), the control module 800 increments time t (step S61) and repeatedly executes the processing from step S51 onward.

As described above, according to the third embodiment, the state estimator 804 of the control module 800 calculates, using the potential measured by the potential sensor 470 as input, the state estimate representing the current density j_{con} at the peripheral portion of the substrate Wf, based on the observation model and the state transition model, wherein the computation based on the observation model is executed using the NN model 810. The NN model 810 is trained so as to output the estimate representing the potential of the plating solution Ps in the vicinity of the peripheral portion, when the state variable representing the current density at the peripheral portion of the substrate Wf is input. The NN model 810 has the same structure and parameter group as the NN model 809 according to the first embodiment. The NN model 809 according to the first embodiment can learn a time-series change in the measured potential quantity in accordance with a change in the plating conditions during the plating processing through training data for machine learning. When a plurality of instances of the plating processing operations are executed consecutively, a change in the plating conditions may occur between one plating processing and another plating processing (for example, the plating conditions may change between the plating processing of forming a plating film on a first substrate and the plating processing of forming the plating film on a second substrate). The NN model 809 can also learn a time-series change in the measured potential quantity in accordance with a change in the plating conditions between such plating processing through training data for machine learning. Therefore, even if a change in the plating conditions occurs, the state estimate representing the current density j_{con} at the peripheral portion can be calculated with high precision. This enhances estimation precision of the current density j_{wafer} at the plating-target surface Wf-a, and also enhances estimation precision of the film thickness distribution w(k,t) of the plating film.

Since the state estimator 804 can sequentially calculate the state estimate representing the current density j_{con} by executing the state estimation processing using the Kalman filter based on the state transition model and the observation model, a highly reliable film thickness distribution w(k,t) can be obtained in real-time. The film thickness distribution of a plating film is conventionally calculated by numerical analysis using computationally intensive numerical simulations, but this method requires many computational resources for performing high-speed calculation. In contrast, the state estimator 804 of the present embodiment can perform high-precision film thickness distribution calculation with high real-time performance using relatively few computational resources.

The current density calculator 812 of the control module 800 can calculate, from the state estimate representing the current density j_{con}, the plating current density j_{wafer} by using the NN model 816. The NN model 816 has the same structure and parameter group as the NN model 815 according to the second embodiment. The NN model 815 according to the second embodiment can learn a time-series change in the peripheral portion current density j_{con} in accordance with a change in the plating conditions during the plating processing through training data for machine learning. When a plurality of instances of the plating processing operations are executed consecutively, a change in the plating conditions may occur between one plating processing and another plating processing (for example, the plating conditions may change between the plating processing of forming a plating film on a first substrate and the plating processing of forming the plating film on a second substrate). The NN model 815 can also learn a time-series change in the peripheral portion current density j_{con} in accordance with a change in the plating conditions between such plating processing through training data for machine learning. Therefore, even if a change in the plating conditions occurs, the current density calculator 812 can estimate the current density j_{wafer} with high precision. This enhances estimation precision of the film thickness distribution w(k,t) of the plating film. VARIATIONS

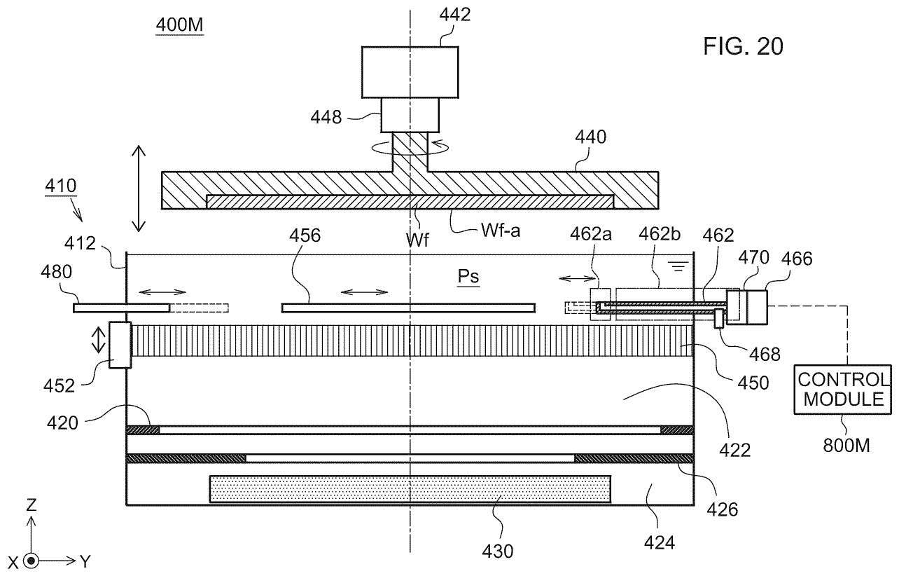

FIG. 20 is a cross-sectional view schematically showing a configuration of a plating module 400M of a variation of the third embodiment. With respect to the plating module 400M of this variation, portions that overlap with those of the plating module 400 of the third embodiment are denoted by the same reference numerals, and description thereof is omitted. A control module 800M has the same functions as the control module 800 of the third embodiment. In the plating module 400M of this variation, the conduit 462 is movable by a driving mechanism 466. The driving mechanism 466 is controlled by the control module 800M. The control module 800M can adjust a position of the opening end 464 of the conduit 462 (see FIG. 13), by controlling an operation of the driving mechanism 466. The driving mechanism 466 can be achieved by a known mechanism such as a motor or a solenoid. As described above, since the potential in the conduit 462 detected by potential sensor 470 is roughly equal to the potential in the vicinity of the opening end 464, the pseudo detection position for the potential sensor 470 can be changed by adjusting the position of the opening end 464 of the conduit 462 with the driving mechanism 466. Noted that while not limited, the driving mechanism 466 may have a function of moving the potential sensor 470 along a radial direction of the substrate Wf.

### FOURTH EMBODIMENT

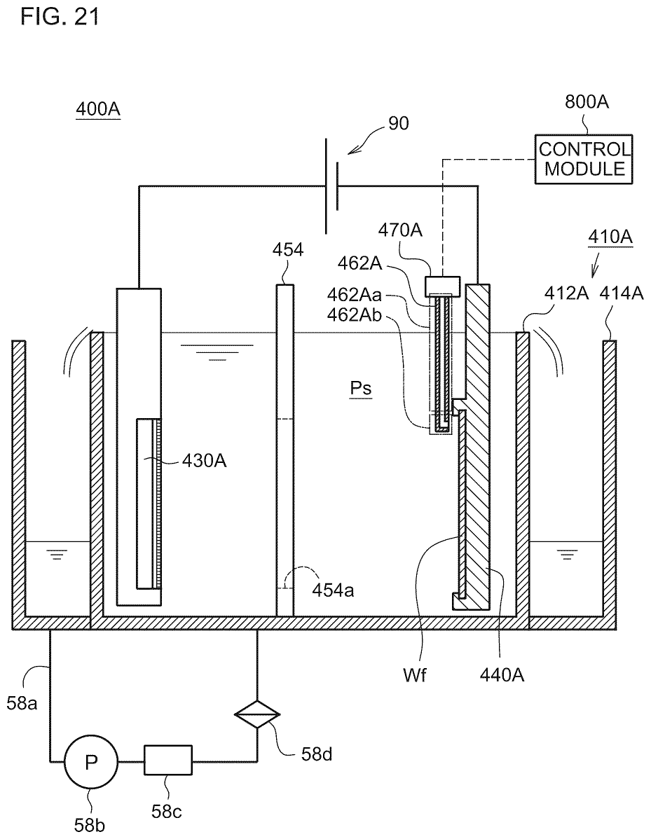

FIG. 21 is a cross-sectional view schematically showing a configuration of a plating module 400A in a fourth embodiment of the present invention. In the fourth embodiment, the substrate Wf is held so as to extend in the vertical direction, that is, the normal direction of the substrate Wf faces the horizontal direction. As shown in FIG. 21, the plating module 400A includes a plating bath 410A that holds the plating solution Ps therein, an anode 430A disposed in the plating bath 410A, and a substrate holder 440A. In the fourth embodiment, a rectangular substrate is used as an example of the substrate Wf, but similar to the third embodiment, the substrate Wf is not limited to a rectangular substrate and may be a circular substrate.

The anode 430Δ is disposed in an inner tank so as to be opposite the plating-target surface of the substrate Wf. The anode 430Δ is connected to a positive electrode of a power supply 90, and the substrate Wf is connected to a negative electrode of the power supply 90 via the substrate holder 440A. Upon applying a voltage between the anode 430A and the substrate Wf, a current flows through the substrate Wf, and a plating film (metal film) is formed on the surface of the substrate Wf in the presence of the plating solution Ps.

The plating bath 410A includes an inner tank 412A in which the substrate Wf and the anode 430A are disposed, and an overflow tank (outer tank) 414A adjacent to the inner tank 412A. The plating solution Ps in the inner tank 412A flows over a side wall of the inner tank 412A and into the overflow tank 414A.

One end of a plating liquid circulation line 58a is connected to a bottom portion of the overflow tank 414A, and the other end of the plating liquid circulation line 58a is connected to a bottom portion of the inner tank 412A. A circulation pump 58b, a thermostatic unit 58c, and a filter 58d are attached to the plating liquid circulation line 58a. When the plating solution Ps flows over the side wall of the inner tank 412A and flows into the overflow tank 414A, the inflowing plating solution is further returned to the inner tank 412A through the plating liquid circulation line 58a from the overflow tank 414A. Accordingly, the plating solution circulates between the inner tank 412A and the overflow tank 414A through the plating liquid circulation line 58a.

The plating module 400A further includes a regulation plate 454 that adjusts a potential distribution on the substrate Wf. The regulation plate 454 is disposed between the substrate Wf and the anode 430A, and has an opening 454a for limiting an electric field in the plating solution.

The plating module 400Δ is provided with a conduit 462A in the plating bath 410A. As an example, the conduit 462A can be formed from a resin such as polypropylene (PP) or polyvinyl chloride (PVC). Similar to the conduit 462 of the third embodiment described above, the conduit 462A includes a first portion 462Aa including an opening end disposed in a region between the substrate Wf and the anode 430A, and a second portion 462Ab disposed in a region away from the region between the substrate Wf and the anode 430A. A potential sensor 470Δ is provided at the second portion 462Ab of the conduit 462A. A detection signal from the potential sensor 470Δ is input to the control module 800A.

In such a plating module 400A in the fourth embodiment, the control module 800A has the same functions as the control module 800 of the third embodiment. Therefore, the control module 800A can estimate the film thickness distribution of the plating film, based on a detection value from the potential sensor 470A. This allows the film thickness distribution of the plating film formed on the plating-target surface of the substrate Wf during the plating processing to be measured in real-time. The control module 800A can also adjust the plating conditions based on the film thickness of the plating film, similar to what is described in the third embodiment.

It should be understood that modifications, additions, and improvements to the above embodiments can be made as appropriate without departing from the spirit and scope of the present invention. The scope of the present invention should be interpreted based on the description of the claims, and should be understood to include equivalents thereof.

1. A method of training a neural network model used for control of a plating apparatus including a plating bath for accommodating a plating solution, a substrate holder for holding a substrate, and an anode disposed in the plating bath so as to be opposite the substrate held by the substrate holder, wherein
upon accepting input data including at least data representing a current density data at a peripheral portion of the substrate, the neural network model is configured to perform inference processing on the input data and calculate inference data representing a potential of the plating solution in a vicinity of the peripheral portion of the substrate, and
the method comprises:
reading training input data and supervisory data corresponding to the training input data from a training data storage in which training data is stored;
causing the training input data to be input to the neural network model;
outputting, by the neural network model, the inference data in accordance with the training input data;
calculating, as a first loss metric, a residual between the supervisory data and the output inference data;
calculating, as a second loss metric, a residual obtained by substituting the output inference data into an equation describing physics phenomena in a region of the plating solution accommodated between the substrate and the anode in the plating bath; and
optimizing parameters of the neural network model by using the first loss metric and the second loss metric.

2. The method according to claim 1, wherein the equation is Laplace's equation relating to the potential.

3. The method according to claim 1, wherein
the parameters defining plating conditions are stored in the training data storage, the plating conditions relating to at least one constituent element of a plating module including at least the plating solution, the plating bath, the substrate holder, and the anode, and
the training input data includes:
data representing the current density at the peripheral portion; and
parameter data representing the parameters that define the plating conditions.

4. The method according to claim 1, wherein
the first loss metric is calculated based on constraint conditions to be satisfied by the potential on boundaries of the region of the plating solution, and
the boundaries of the region include a boundary between the substrate and the plating solution, and a boundary between the anode and the plating solution.

5. The method according to claim 4, wherein the constraint conditions include the Dirichlet boundary condition and the Neumann boundary condition.

6. A plating apparatus comprising:
a plating bath for accommodating a plating solution;
a substrate holder for holding a substrate;
an anode disposed in the plating bath so as to be opposite the substrate held by the substrate holder;
a sensor configured to measure a potential of the plating solution in a vicinity of a peripheral portion of the substrate held by the substrate holder; and
a state estimator configured to calculate, using the measured potential as input, a state estimate representing a current density at the peripheral portion of the substrate, based on an observation model and a state transition model, wherein
the state estimator is configured to execute computation based on the observation model by using a neural network model trained using the method according to claim 1, and
when a state variable representing the current density at the peripheral portion is input, the trained neural network model is used as a neural network model configured to output an estimate representing the potential of the plating solution in the vicinity of the peripheral portion.

7. The plating apparatus according to claim 6, further comprising a parameter data storage in which parameters defining plating conditions are stored, the plating conditions relating to at least one constituent element of a plating module including at least the plating solution, the plating bath, the substrate holder, and the anode, wherein
the trained neural network model includes:
an input layer configured to accept parameter data representing the parameters provided from the parameter data storage, and the state variable representing the current density at the peripheral portion;
an output layer configured to output the estimate representing the potential in the vicinity of the peripheral portion; and
an intermediate layer that couples the input layer and the output layer.

8. The plating apparatus according to claim 6, wherein
the state transition model is a model that describes a temporal transition of the state variable representing the current density at the peripheral portion,
the observation model is a model that describes a relationship between the potential measured by the sensor and a state variable representing the current density at the peripheral portion, and
the state estimator is configured to calculate the state estimate by executing processing using a Kalman filter based on the state transition model and the observation model.

9. A method of training a neural network model used for control of a plating apparatus including a plating bath for accommodating a plating solution, a substrate holder for holding a substrate, and an anode disposed in the plating bath so as to be opposite the substrate held by the substrate holder, wherein
upon accepting input data including at least data representing a current density data at a peripheral portion of the substrate, the neural network model is configured to perform inference processing on the input data and calculate inference data representing a current density in an inner region located inward of the peripheral portion on the substrate, and
the method comprises:
reading training input data and supervisory data corresponding to the training input data from a training data storage in which training data is stored;
causing the training input data to be input to the neural network model;
outputting, by the neural network model, the inference data in accordance with the training input data;
calculating, as a loss metric, a residual obtained by substituting the supervisory data and the output inference data into an equation describing physics phenomena in a region including a boundary between a plating-target surface of the substrate and the plating solution in the plating bath; and
optimizing parameters of the neural network model by using the loss metric.

10. The method according to claim 9, wherein
the parameters defining plating conditions are stored in the training data storage, the plating conditions relating to at least one constituent element of a plating module including at least the plating solution, the plating bath, the substrate holder, and the anode, and
the training input data includes:
data representing the current density at the peripheral portion; and
parameter data representing the parameters that define the plating conditions.

11. A plating apparatus comprising:
a plating bath for accommodating a plating solution;
a substrate holder for holding a substrate;
an anode disposed in the plating bath so as to be opposite the substrate held by the substrate holder;
a sensor configured to measure a potential of the plating solution in a vicinity of a peripheral portion of the substrate held by the substrate holder; and
a state estimator configured to calculate, from the measured potential, a state estimate representing a current density at the peripheral portion of the substrate; and
a current density calculator configured to calculate, from the state estimate calculated by the state estimator, a distribution of a current density in an inner region of the substrate located inward of the peripheral portion of the substrate, by using the neural network model trained using the method according to claim 9.

12. The plating apparatus according to claim 11, further comprising a parameter data storage in which parameters defining plating conditions are stored, the plating conditions relating to at least one constituent element of a plating module including at least the plating solution, the plating bath, the substrate holder, and the anode, wherein
the trained neural network model includes:
an input layer configured to accept parameter data representing the parameters provided from the parameter data storage, and the state estimate provided from the state estimator;
an output layer configured to output the distribution of the current density in the inner region; and
an intermediate layer that couples the input layer and the output layer.

13. A computer-readable non-transitory storage medium comprising a computer program including a plurality of instructions that when executed by a processor, causing the processor to implement the method according to claim 1.

14. A computer-readable non-transitory storage medium comprising a computer program including a plurality of instructions that when executed by a processor, causing the processor to implement the method according to claim 9.
